(19) United States
(12) Patent Application Publication
(10) Pub. No.: US 2016/0065980 A1
(43) Pub. Date: Mar. 3, 2016

(54) VIDEO STREAM ENCODING METHOD ACCORDING TO A LAYER IDENTIFIER EXPANSION AND AN APPARATUS THEREOF, AND A VIDEO STREAM DECODING METHOD ACCORDING TO A LAYER IDENTIFIER EXPANSION AND AN APPARATUS THEREOF

(71) Applicant: SAMSUNG ELECTRONICS CO., LTD., Gyeonggi-do (KR)

(72) Inventors: Byeong-doo CHOI, Suwon-si (KR); Min-woo PARK, Hwaseong-si (KR); Ho-cheon WEY, Seongnam-si (KR); Jae-won YOON, Seoul (KR); Jin-young LEE, Hwaseong-si (KR); Yong-jin CHO, Seoul (KR)

(73) Assignee: SAMSUNG ELECTRONICS CO., LTD., Suwon-si (KR)

(21) Appl. No.: 14/782,508

(22) PCT Filed: Apr. 7, 2014
(86) PCT No.: PCT/KR2014/003005

§ 371 Date: Oct. 5, 2015

Related U.S. Application Data
(60) Provisional application No. 61/808,816, filed on Apr. 5, 2013.

(51) Int. Cl. H04N 19/44; H04N 19/172; H04N 19/187

(52) U.S. Cl. CPC H04N 19/44; H04N 19/187; H04N 19/172

(57) ABSTRACT

Provided is a video stream decoding method including: obtaining a first identifier of at least one decoding target layer image from among a plurality of layer images from a bitstream including a plurality of pieces of layer encoding image data; obtaining a second identifier including information expressing a layer identifier outside of an expression range of the first identifier from the bitstream; determining a layer identifier based on the first and second identifiers; and reconstructing an image by decoding the decoding target layer image by using the determined layer identifier.

### RELATED APPLICATIONS

This is a national stage application of PCT/KR2014/003005 filed on Apr. 7, 2014 which claims the benefit of U.S. Provisional Application 61/808,816 filed on Apr. 5, 2013, in the United States Patent and Trademark Office, the disclosures of which are hereby incorporated herein in their entirety by reference.

### BACKGROUND

1. Field

Apparatuses and methods consistent with exemplary embodiments relate to video encoding and decoding, encoding an image sequence according to at least one layer, and decoding a received video stream according to at least one layer.

2. Related Art

As hardware for reproducing and storing high resolution or high quality video content is being developed and supplied, a need for a video codec for effectively encoding or decoding the high resolution or high quality video content is increasing. According to a related art video codec, a video is encoded according to a limited encoding method based on a macroblock having a predetermined size.

Image data of a spatial region is transformed into coefficients of a frequency region via frequency transformation. According to a video codec, an image is split into blocks having a predetermined size, discrete cosine transformation (DCT) is performed on each block, and frequency coefficients are encoded in block units, for rapid calculation of frequency transformation. Compared with image data of a spatial region, coefficients of a frequency region are easily compressed. In particular, since an image pixel value of a spatial region is expressed according to a prediction error via inter prediction or intra prediction of a video codec, when frequency transformation is performed on the prediction error, a large amount of data may be transformed to 0. According to a video codec, an amount of data may be reduced by replacing data that is consecutively and repeatedly generated with small-sized data.

A multi-layer video codec encodes and decodes a base layer video and at least one enhancement layer video. Amounts of data of the base layer video and the enhancement layer video may be reduced by removing temporal/spatial redundancy and layer redundancy of the base layer video and the enhancement layer video.

### SUMMARY

In high efficiency video coding (HEVC), a bit length of a general layer identifier (nuh_layer_id) is 6 bits. Accordingly, the maximum number of layers distinguished in 6 bits is 64. However, in a situation where super multi-view image encoding and decoding is required or in high-end devices, support for a number of layers greater than 64 are required.

According to an aspect of an exemplary embodiment, an image decoding method includes: obtaining a first identifier of at least one decoding target layer image from among a plurality of layer images from a bitstream including a plurality of pieces of layer encoding image data; obtaining a second identifier including information expressing a layer identifier outside an expression range of the first identifier from the bitstream; determining a layer identifier by using the first and second identifiers; and reconstructing an image by decoding the decoding target layer image by using the determined layer identifier.

According to an aspect of an exemplary embodiment, an image decoding method includes: obtaining a first identifier of at least one decoding target layer image from among a plurality of layer images from a bitstream including a plurality of pieces of layer encoding image data; obtaining a second identifier including information expressing a layer identifier outside an expression range of the first identifier from the bitstream; determining a layer identifier by using the first and second identifiers; and reconstructing an image by decoding the decoding target layer image by using the determined layer identifier.

The determining of the layer identifier may include determining the layer identifier by using the first and second identifiers when the first identifier indicates a maximum value of the first identifier.

The image decoding method may further include obtaining, from the bitstream, expansion indication information indicating whether the second identifier includes information for the layer identifier, wherein the determining of the layer identifier may include determining whether to use the second identifier for determining the layer identifier according to the expansion indication information.

The second identifier may be obtained from at least one of a slice header, a parameter set header, and a network abstract layer (NAL) unit header.

The first and second identifiers may be obtained from an NAL unit header.

The second identifier may be obtained from a next identifier location of the first identifier in an identifier arrangement order of the bitstream.

The second identifier may be a temporal identifier included in the bitstream.

The reconstructing of the image by decoding the decoding target layer image by using the determined layer identifier may include determining a temporal identifier value of the decoding target layer image according to a value of a temporal identifier of a base layer.

The reconstructing of the image may include: obtaining output layer information in an output layer set from the bitstream by using an expanded maximum layer identifier; and decoding the target layer image by using the output layer information.

The obtaining of the output layer information may include: obtaining an identifier of a maximum layer in a video parameter set from the bitstream; obtaining a number of bits assigned to the second identifier; and determining an identifier of an expanded maximum layer based on the number of bits assigned to the second identifier and the maximum layer identifier.

The reconstructing of the image may include: obtaining inter-layer direct reference information according to a maximum number of expanded layers; and decoding the target layer image by using the inter-layer direct reference information.

The obtaining of the inter-layer direct reference information may include: obtaining an identifier indicating a maximum layer number in a video parameter set from the bitstream; obtaining a number of bits assigned to the second identifier; and determining the maximum number of the expanded layers based on the identifier indicating the maximum layer number and a number of bits assigned to the expanded identifier.

According to an aspect of another exemplary embodiment, an image encoding method includes: generating encoding data of at least one encoding target layer image from among a plurality of layer images by using an input image; generating a bitstream by using a first identifier expressing a layer identifier of the encoding target layer image and a second identifier for expressing a layer identifier outside an expression range of the first identifier.

The generating of the bitstream by using the first identifier expressing the layer identifier of the encoding target layer image and the second identifier for expressing the layer identifier outside the expression range of the first identifier may include setting the first identifier to have a maximum value when the layer identifier exceeds a range expressing the first identifier.

The bitstream may further include expansion indication information indicating that the second identifier comprises information for expressing the layer identifier.

The second identifier may be included in any one of a slice header, a parameter set header, and a network abstract layer (NAL) unit header.

The first and second identifiers may be obtained from a NAL unit header.

The second identifier may be arranged at a next identifier location of the first identifier in an identifier arrangement order in the bitstream.

The second identifier may be a temporal identifier included in the bitstream.

The encoding target layer image may be an enhancement layer image, and when a value of a temporal identifier of the encoding target layer image is same as a value of a temporal identifier of a base layer image, the temporal identifier of the encoding target layer image may be used as the second identifier.

According to an aspect of another exemplary embodiment, an image decoding apparatus includes: a bitstream parser configured to obtain a first identifier of at least one decoding target layer image from among a plurality of layer images from a bitstream including a plurality of pieces of layer encoding image data, and obtain a second identifier including information expressing a layer identifier outside an expression range of the first identifier from the bitstream; and a decoder configured to reconstruct an image by decoding the decoding target layer image by using a layer identifier determined by using the first and second identifiers.

According to an aspect of another exemplary embodiment, an image encoding apparatus includes: an encoder configured to generate encoding data of at least one encoding target layer image from among a plurality of layer images by using an input image; and a bitstream generator configured to generate a bitstream by using a first identifier expressing a layer identifier of the encoding target layer image and a second identifier for expressing a layer identifier outside an expression range of the first identifier.

According to an aspect of another exemplary embodiment, a computer-readable medium has recorded thereon a program, which when executed by a computer, performs at least one of an image decoding method and an image encoding method.

According to an exemplary embodiment, an encoding apparatus provides a method of expanding a layer identifier in order to support at least 64 layers. By using encoding and decoding methods according to an exemplary embodiment of the present disclosure, a layer identifier is able to express at least 64 layers by expanding a bit length of the layer identifier in 6 bits.

### BRIEF DESCRIPTION OF THE DRAWINGS

FIG. 1A is a block diagram of a video stream encoding apparatus according to various exemplary embodiments.

FIG. 1B is a flowchart of a video stream encoding method according to various exemplary embodiments.

FIG. 2A is a block diagram of a video stream decoding apparatus according to various exemplary embodiments.

FIG. 2B is a flowchart of a video stream video decoding method according to various exemplary embodiments.

FIG. 3A is a diagram for describing a layer identifier expansion encoding method according to a first exemplary embodiment.

FIG. 3B is a diagram for describing a layer identifier expansion decoding method according to a first exemplary embodiment.

FIG. 4 illustrates a syntax structure according to an exemplary embodiment of the present disclosure.

FIG. 5 illustrates an inter-layer prediction structure according to an exemplary embodiment.

FIG. 6 illustrates an inter-layer prediction structure of a multi-view video stream.

FIG. 7 illustrates a structure of a network abstract layer (NAL) unit.

FIG. 8 is a block diagram of a video encoding apparatus based on coding units according to a tree structure, according to various exemplary embodiments.

FIG. 9 is a block diagram of a video decoding apparatus based on coding units according to a tree structure, according to various exemplary embodiments.

FIG. 10 is a diagram for describing a concept of coding units according to various exemplary embodiments.

FIG. 11 is a block diagram of an image encoder based on coding units, according to various exemplary embodiments.

FIG. 12 is a block diagram of an image decoder based on coding units, according to various exemplary embodiments.

FIG. 13 is a diagram illustrating deeper coding units according to depths, and partitions, according to various exemplary embodiments.

FIG. 14 is a diagram for describing a relationship between a coding unit and transformation units, according to various exemplary embodiments.

FIG. 15 is a diagram for describing encoding information of coding units corresponding to a coded depth, according to various exemplary embodiments.

FIG. 16 is a diagram of deeper coding units according to depths, according to various exemplary embodiments.

FIGS. 17 through 19 are diagrams for describing a relationship between coding units, prediction units, and transformation units, according to various exemplary embodiments.

FIG. 20 is a diagram for describing a relationship between a coding unit, a prediction unit, and a transformation unit, according to encoding mode information of Table 5.

FIG. 21 is a diagram of a physical structure of a disc in which a program is stored, according to various exemplary embodiments.

FIG. 22 is a diagram of a disc drive for recording and reading a program by using a disc.

FIG. 23 is a diagram of an overall structure of a content supply system for providing a content distribution service.

FIGS. 24 and 25 are diagrams respectively of an external structure and an internal structure of a mobile phone to which a video encoding method and a video decoding method are applied, according to various exemplary embodiments.

FIG. 26 is a diagram of a digital broadcast system to which a communication system is applied, according to various exemplary embodiments.

FIG. 27 is a diagram illustrating a network structure of a cloud computing system using a video encoding apparatus and a video decoding apparatus, according to various exemplary embodiments.

### DETAILED DESCRIPTION OF EXEMPLARY EMBODIMENTS

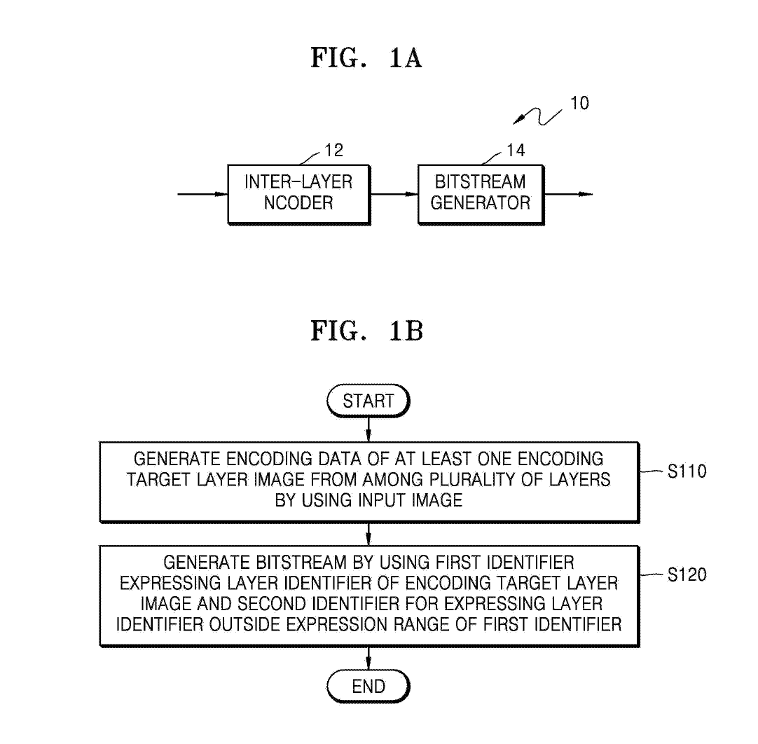

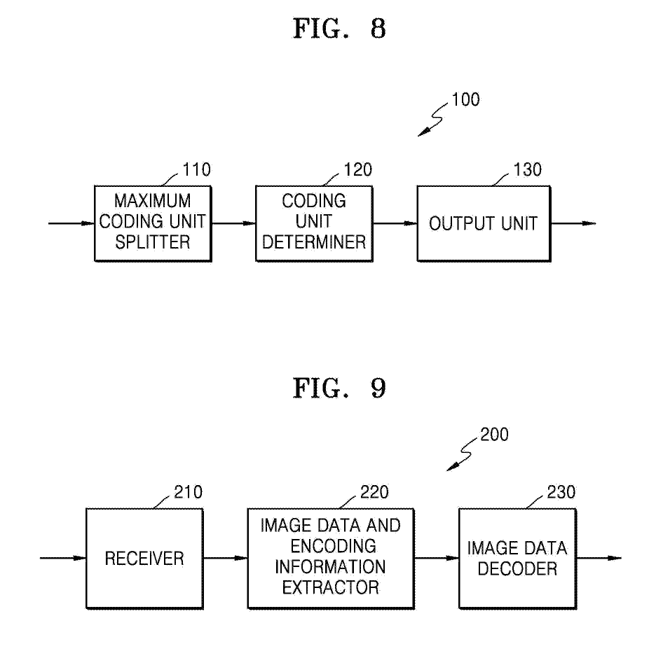

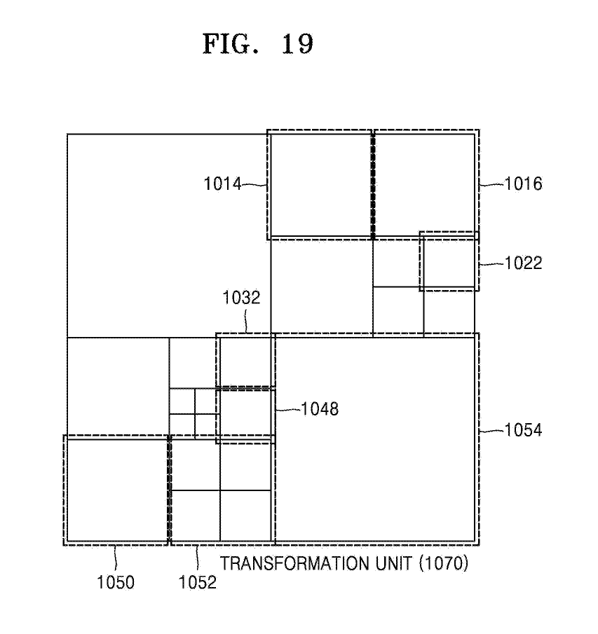

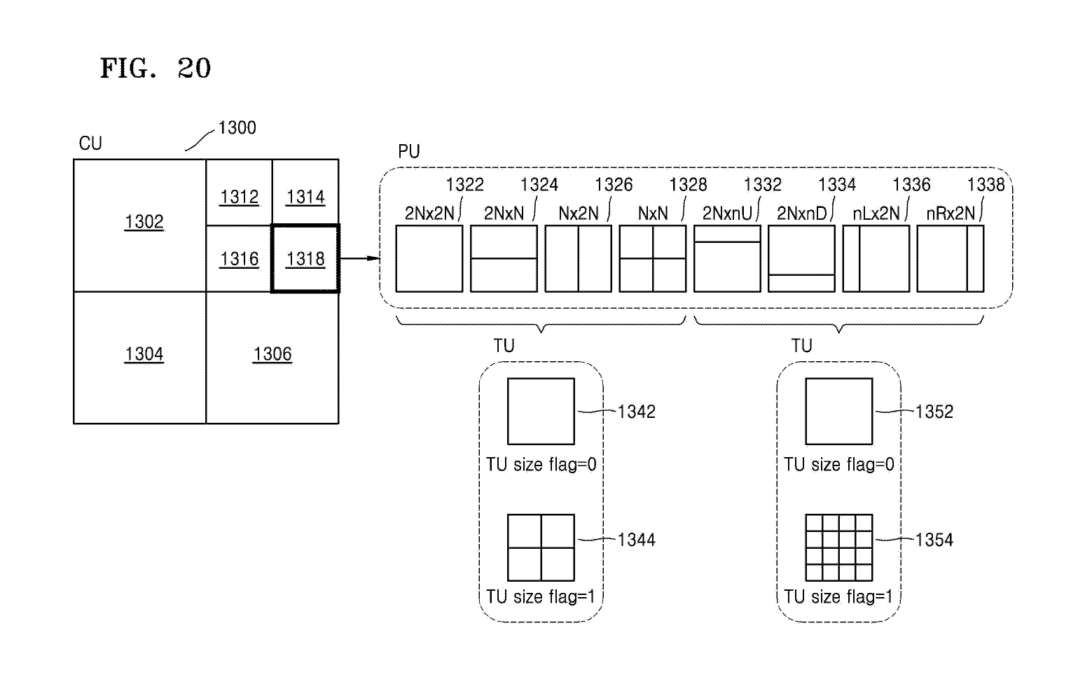

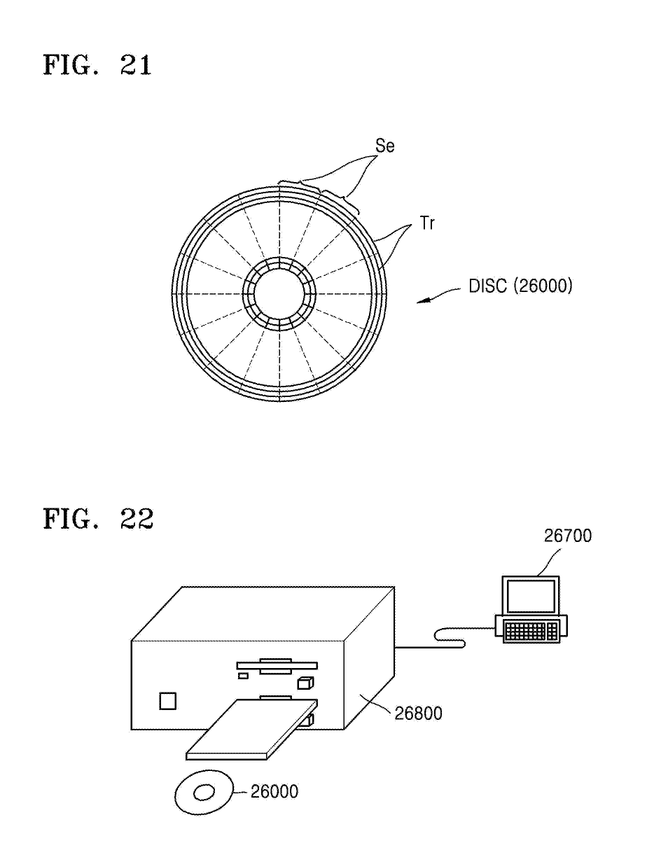

Hereinafter, a video stream encoding apparatus, a video stream decoding apparatus, a video stream encoding method, and a video stream decoding method, according to various exemplary embodiments, will be described with reference to FIGS. 1A through 7. In addition, a video encoding apparatus, a video decoding apparatus, a video encoding method, and a video decoding method, according to various exemplary embodiments, which are based on coding units having a tree structure, will be described with reference to FIGS. 8 through 20. Various exemplary embodiments to which a video stream encoding method, a video stream decoding method, a video encoding method, and a video decoding method, according to exemplary embodiments of FIGS. 1A through 20, are applicable, will be described with reference to FIGS. 21 through 27. Hereinafter, an ‘image’ may denote a still image or a moving image of a video, or a video itself.

First, a video stream encoding apparatus, a video stream encoding method, a video stream decoding apparatus, and a video stream decoding method will be described with reference to FIGS. 1A through 7.

FIG. 1A is a block diagram of a video stream encoding apparatus 10 according to various exemplary embodiments. FIG. 1B is a flowchart of a video stream encoding method according to various exemplary embodiments.

The video stream encoding apparatus 10 according to various exemplary embodiments includes an inter-layer encoder 12 and a bitstream generator 14.

The video stream encoding apparatus 10 according to various exemplary embodiments may classify a plurality of video streams according to layers and encode each of the video streams according to a scalable video coding method. The video stream encoding apparatus 10 may encode base layer images and enhancement layer images in different layers.

For example, a multiview video may be encoded according to a scalable video coding method. Left view images may be encoded as base layer images and right view images may be encoded as enhancement layer images. Alternatively, central view images, left view images, and right view images may be each encoded, wherein the central view images may be encoded as base layer images, the left view images may be encoded as first enhancement layer images, and the right view images may be encoded as second enhancement layer images. An encoding result of the base layer images may be output as a base view layer stream, and encoding results of the first and second enhancement layer images may be respectively output as a first enhancement layer image stream and a second enhancement layer image stream.

When there are at least three enhancement layers, base layer images and first through K-th enhancement layer images may be encoded. Accordingly, an encoding result of the base layer images may be output as a base layer stream, and encoding results of the first through K-th enhancement layer images may be respectively output as first through K-th enhancement layer streams.

The video stream encoding apparatus 10 according to various exemplary embodiments may perform inter prediction in which a current image is predicted by referring to images of the same layer. By performing inter prediction, a motion vector indicating motion information between a current image and a reference image, and a residual between the current image and the reference image may be generated.

The video stream encoding apparatus 10 according to various exemplary embodiments may perform inter-layer prediction to predict enhancement layer images by referring to base layer images. The video stream encoding apparatus 10 may perform inter-layer prediction for predicting second enhancement layer images by referring to first enhancement layer images. By performing inter-layer prediction, a position difference component between a current image and a reference image of a layer different from that of the current image and a residual between the current image and the reference image of the different layer may be generated.

When the video stream encoding apparatus 10 according to an exemplary embodiment allows at least two enhancement layers, inter-layer prediction may be performed between one base layer image and the at least two enhancement layer images according to a multi-layer prediction structure.

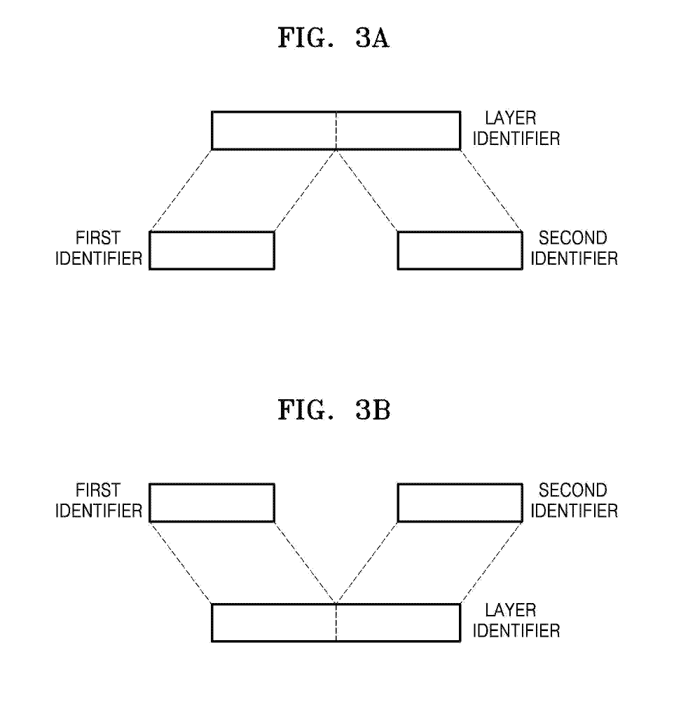

An inter-layer prediction structure will be described later with reference to FIG. 3.

The video stream encoding apparatus 10 according to various exemplary embodiments encodes each image of a video according to blocks, per layer. A type of a block may be a square or a rectangle, or may be an arbitrary geometrical shape. The block is not limited to a data unit having a uniform size. A block according to an exemplary embodiment may be, from among coding units having a tree structure, a maximum coding unit, a coding unit, a prediction unit, or a transformation unit. For example, the video stream encoding apparatus 10 may split and encode, per layer, images according to the HEVC standard, into blocks having a quad-tree structure. Video encoding and decoding methods based on coding units according to a tree structure will be described later with reference to FIGS. 8 through 20. Inter prediction and inter-layer prediction may be performed based on a data unit of a coding unit, a prediction unit, or a transformation unit.

The inter-layer encoder 12 according to various exemplary embodiments may encode an image sequence according to at least one layer. The inter-layer encoder 12 may generate symbol data by performing source coding operations including inter prediction or intra prediction, per layer. For example, the inter-layer encoder 12 may generate symbol data by performing transformation and quantization on an image block including result data of performing inter prediction or intra prediction on image samples, and generate a bitstream by performing entropy encoding on the symbol data.

The inter-layer encoder 12 may generate a bitstream by encoding an image sequence per layer. As described above, the inter-layer encoder 12 may encode a current layer image sequence by referring to symbol data of a layer different from the current layer image sequence, via inter-layer prediction. Accordingly, the inter-layer encoder 12 according to various exemplary embodiments may encode an image sequence of each layer by referring to an image sequence of a different layer or the same layer according to a prediction mode. For example, in an intra mode, a current sample may be predicted by using adjacent samples in a current image, and in an inter mode, a current image may be predicted by using another image in the same layer. In an inter-layer prediction mode, a current image may be predicted by using a reference image of the same picture order count (POC) as the current image from among other layer images.

The inter-layer encoder 12 may encode a multi-view video, and encode an image sequence of different views per layer. An inter-layer prediction structure regarding the multi-view video may be an inter-view prediction structure since a current view image is encoded by referring to another view image.

In high efficiency video coding (HEVC), a bit length of a general layer identifier (nuh_layer_id) is 6 bits. Accordingly, a maximum number of layers distinguished in 6 bits is 64. However, in a situation where super multi-view image encoding and decoding is required or in high-end devices, a number of layers that is greater than 64 may be need to be used. In order to support at least 64 layers, an encoding apparatus according to an exemplary embodiment of the present disclosure provides a method of expanding a layer identifier. By expanding a bit length of a layer identifier of 6 bits via encoding and decoding methods according to an exemplary embodiment of the present disclosure, the layer identifier is able to express at least 64 layers.

The inter-layer encoder 12 according to an exemplary embodiment may generate an encoding image by encoding a base layer image and an enhancement layer image by using an input image. The inter-layer encoder 12 generates a layer identifier (nuh_layer_id) per encoding image of each layer in order to distinguish layers while encoding a layer image.

The inter-layer encoder 12 may express a layer identifier of a layer image by using more than 6 bits. However, in current HEVC, a layer identifier is expressed in 6 bits, and thus in order to express greater than 64 layer identifiers while not changing configuration of the current HEVC, the inter-layer encoder 12 may express a layer identifier by assigning an additional identifier.

The inter-layer encoder 12 according to an exemplary embodiment of the present disclosure may form a layer identifier by using a plurality of identifiers. For example, the inter-layer encoder 12 may form a layer identifier by using an integer number of identifiers. For example, the inter-layer encoder 12 may express a layer identifier by using two identifiers including a first identifier and a second identifier. A method of expressing a layer identifier by using two identifiers will now be described. By describing the method of expressing a layer identifier by using two identifiers, a method of using a plurality of identifiers will be described.

Hereinafter, a method of forming, by the inter-layer encoder 12 according to an exemplary embodiment of the present disclosure, a first identifier and a second identifier will be described.

FIG. 3A is a diagram for describing a layer identifier expansion encoding method according to a first exemplary embodiment. When a layer identifier is expressed by using N bits, the inter-layer encoder 12 according to the first exemplary embodiment of the present disclosure assigns an a number of most significant bits (MSBs) to a first identifier and an a number of least significant bits (LSBs) to a second identifier, thereby expressing the layer identifier by using the first and second identifiers. For example, when N is increased, a bit length of the second identifier may be increased. An encoding apparatus and a decoding apparatus may be aware of a bit length for expressing the layer identifier, a bit length of the MSBs assigned to the first identifier, and a bit length of the LSBs assigned to the second identifier, and the encoding apparatus and the decoding apparatus may encode and decode a value of the layer identifier by using the first and second identifiers, by using the bit lengths.

For example, N may be a maximum bit length for expressing a layer identifier promised between the encoding and decoding apparatuses, and a may be a bit length of a first identifier. For example, when maximum 9 bits is required to express a layer identifier and a bit length of a first identifier is 6 bits, 6 MSBs of the layer identifier may be assigned to the first identifier and 3 LSBs of the layer identifier may be assigned to a second identifier to form the first and second identifiers.

According to the first exemplary embodiment, in order to signal the decoding apparatus that a value of a layer identifier is expressed by using a plurality of identifiers, the inter-layer encoder 12 may generate a layer expansion indicator indicating that the value of the layer identifier is expressed by using the plurality of identifiers. The layer expansion indicator generated by the inter-layer encoder 12 may be signaled to the decoding apparatus. For example, the inter-layer encoder 12 may set a value of the layer expansion indicator to 1 when the value of the layer identifier is expressed by using the plurality of identifiers.

The inter-layer encoder 12 may signal the layer expansion indicator to the decoding apparatus. The layer expansion indicator may be included in at least one of a network abstract layer (NAL) unit header, a parameter set, and a slice segment. For example, the layer expansion indicator may be included in a parameter set header or a slice segment header. A parameter set includes a video parameter set, a sequence parameter set, and a picture parameter set. For example, the layer expansion indicator may be included in a video parameter set extension.

The inter-layer encoder 12 according to a second exemplary embodiment of the present disclosure may set a pre-set certain value to one of the first and second identifiers, and set a value determined by using the value of the layer identifier and the pre-set certain value according to a pre-set method to the other one of the first and second identifiers. For example, the first and second identifiers may be formed such that the value of the layer identifier is expressed by using the sum of the values of the first and second identifiers. At this time, when the value of the first or second identifier is the pre-set certain value, the decoding apparatus may determine that the layer identifier is expressed by using the plurality of identifiers. Accordingly, in the second exemplary embodiment, generating and signaling of a layer expansion indicator according to the first exemplary embodiment may be omitted.

For example, when the value of the layer identifier is outside a range of a value expressible in the first identifier, the inter-layer encoder 12 may set the first identifier to express the pre-set certain value, and set the second identifier to have a value obtained by subtracting the pre-set certain value from the value of the layer identifier. In this case, when the value of the first identifier is the pre-set certain value, the decoding apparatus may determine that the layer identifier is expressed by using the plurality of identifiers. According to another exemplary embodiment, the inter-layer encoder 12 may set a maximum value expressible by the first identifier to the first identifier, and set a value obtained by subtracting the maximum value expressible by the first identifier from the value of the layer identifier to the second identifier. Moreover, as described above, the inter-layer encoder 12 may set a certain value to the second identifier and set the value of the first identifier by using the value of the second identifier and the value of the layer identifier.

The inter-layer encoder 12 may generate the first and second identifiers to have bit sizes in independent integer sizes. For example, the first identifier may have a bit length of 6 bits and the second identifier may have a bit length of 3 bits. As another example, the first identifier may have a bit length of 6 bits and the second identifier may have a bit length of 4, 5, or 10 bits.

The inter-layer encoder 12 may generate the first and second identifiers to be included in different data units. For example, the first and second identifiers may be included, together or separately, in at least one of an NAL unit header, a parameter set, or a slice segment. For example, the first and second identifiers may be included in a parameter set header or a slice segment header. Here, a parameter set may be a video parameter set, a sequence parameter set, or a picture parameter set. For example, the first and second identifiers may be included in video parameter set extension.

For example, the first identifier may be included in a header of an NAL unit. For example, the first identifier may be a layer identifier included in a header of an NAL unit. Accordingly, the first identifier may be nuh_layer_id of 6 bits included in a header of an NAL unit.

The second identifier may also be included in a header of an NAL unit. For example, the second identifier may be a temporal identifier included in a header of an NAL unit. In a header of an NAL unit, three bits are assigned according to temporal identifiers. For example, the second identifier may be temporal_id of 3 bits included in a header of an NAL unit.

When all layers are limited to having the same temporal identifier value in one access unit, a value of a temporal identifier of layers other than a base layer may be interpreted as another purpose. For example, a temporal identifier may be interpreted as additional bits for expressing a layer identifier. For example, when a temporal identifier of 3 bits is used as additional bits for expressing a layer identifier, a bit length of a layer identifier of 6 bits may be expanded to 9 bits. A layer identifier may have 512 values. In this case, the layer identifier may express 511 layers.

The encoding apparatus may use a flag in order to indicate whether a layer identifier is expanded and expressed by using the second identifier. For example, the encoding apparatus may signal to the decoding apparatus whether the layer identifier is expanded by using the second identifier, by using layer_id_extension_flag. For example, layer_id_extension_flag may be a flag expressed in 1 bit.

For example, when all layers are limited to having the same temporal identifier value in one access unit, the encoding apparatus may use a temporal identifier of layers other than a base layer as a second identifier, and set a value of layer_id_extension_flag to 1 to indicate that the temporal identifier is used as the second identifier. Accordingly, an encoder may indicate that the temporal identifiers of all layers are synchronized by setting the value of laye_id_extension_flag to 1. At this time, a temporal identifier value of layers having a nonzero layer identifier may be inferred from a temporal identifier value of a base layer. Accordingly, a temporal identifier may be used as an additional bit of the layer identifier.

According to another exemplary embodiment, the second identifier may be included as an additional bit in an NAL unit header. For example, the inter-layer encoder according to an exemplary embodiment of the present disclosure may expand a size of an NAL unit header as much as the bit length of the second identifier, and include the second identifier in the NAL unit header.

According to another exemplary embodiment, the second identifier may be included in at least one of a video parameter set header, a sequence parameter set header, and a slice segment header, in a certain bit length.

The second identifier may be located at a next identifier location of the first identifier regarding an identifier arrangement order in a bitstream. For example, the first and second identifiers may both be included in an NAL unit header. For example, the first identifier may be a layer identifier included in an NAL unit header, and the second identifier may be a temporal identifier included in the NAL unit header.

In order for an inter-layer decoder 24 to obtain the first and second identifiers, locations where the first and second identifiers are located in an NAL unit, and bit lengths of the first and second identifiers may be pre-set in the encoding and decoding apparatuses. For example, syntaxes for obtaining the first and second identifiers from the NAL unit may be pre-defined in the encoding and decoding apparatuses. Similarly, a syntax may be pre-defined, in the encoding and decoding apparatuses, with respect to a layer expansion indicator indicating that a layer identifier value is expressed by using a plurality of identifiers.

The bitstream generator according to an exemplary embodiment may generate a bitstream by using the first identifier expressing a layer identifier of an encoding target layer image and the second identifier for expressing a layer identifier outside of an expression range of the first identifier. The bitstream generator may generate the bitstream to further include expansion indication information indicating that the second identifier includes information for expressing the layer identifier.

The bitstream generator may generate the bitstream such that at least one of the first and second identifiers is included in any one of a slice header, a parameter set header, and an NAL unit header. For example, the bitstream generator may generate the bitstream such that the first and second identifiers are included in an NAL unit header. The bitstream generator may generate the bitstream such that the second identifier is arranged at the next identifier location of the first identifier according to the identifier arrangement order in the bitstream. The bitstream generator may arrange the second identifier at a location of a temporal identifier.

FIG. 1B is a diagram for describing a method of generating, by the video stream encoding apparatus 10, an identifier expressing a layer identifier. Hereinafter, detailed operations of the video stream encoding apparatus 10 generating a layer identifier will be described with reference to FIG. 1B. First, the encoding apparatus generates encoding data of at least one encoding target layer image from among a base layer image and an enhancement layer image, by using an input image, in operation S110.

Then, the encoding apparatus generates a bitstream by using a first identifier expressing a layer identifier of the encoding target layer image and a second identifier for expressing a layer identifier outside of an expression range of the first identifier, in operation S120. The encoding apparatus may indicate that values of the layer identifiers are expressed by using the first and second identifiers.

For example, when the layer identifier is outside a range expressible in the first identifier, the encoding apparatus may set the value of the layer identifier to a pre-set certain value. As another example, the encoding apparatus may set the first identifier to have a maximum value to indicate that the value of the layer identifier is expressed by using the first and second identifiers. The encoding apparatus may set values of the first and second identifiers such that the value of the layer identifier is generated by using the first and second identifiers according to a pre-set method. According to an exemplary embodiment, the encoding apparatus may set the values of the first and second identifiers such that the value of the layer identifier is generated by adding the values of the first and second identifiers. According to another exemplary embodiment, the encoding apparatus may simply set the second identifier to indicate the value of the layer identifier.

As another example, the encoding apparatus may generate the bitstream to include expansion indication information indicating that the second identifier includes information for expressing the layer identifier. In this case, the encoding apparatus may set the first and second identifiers to include a certain bit portion of the layer identifier. For example, the encoding apparatus may set the first identifier to include an MSB of the layer identifier as much as a pre-set number of bits, and set the second identifier to include an LSB of the layer identifier as much as a pre-set number of bits. For example, the second identifier may include the LSB of the layer identifier, which is not included in the first identifier.

The encoding apparatus may include output layer information in the bitstream by using a maximum layer identifier. The output layer information is information of a layer to be decoded and output in an output layer set. The maximum layer identifier is an identifier value of a maximum layer to be expressed in a layer identifier in an encoding operation. The encoding apparatus may include inter-layer direct reference information in the bitstream according to a maximum number of layers. The maximum number of layers is a maximum number of layers generated during the encoding operation.

The encoding apparatus may generate the bitstream such that at least one of the first and second identifiers is included in any one of a slice header, a parameter set header, and an NAL unit header. For example, the encoding apparatus may generate the bitstream such that the first and second identifiers are included in an NAL unit header. The encoding apparatus may generate the bitstream such that the second identifier is arranged at a next identifier location of the first identifier according to an identifier arrangement order in the bitstream. When the encoding target layer image is an enhancement layer image and a value of a temporal identifier of the encoding target layer image is the same as a value of a temporal identifier of a base layer image, the encoding apparatus may arrange the second identifier at a location of a temporal identifier.

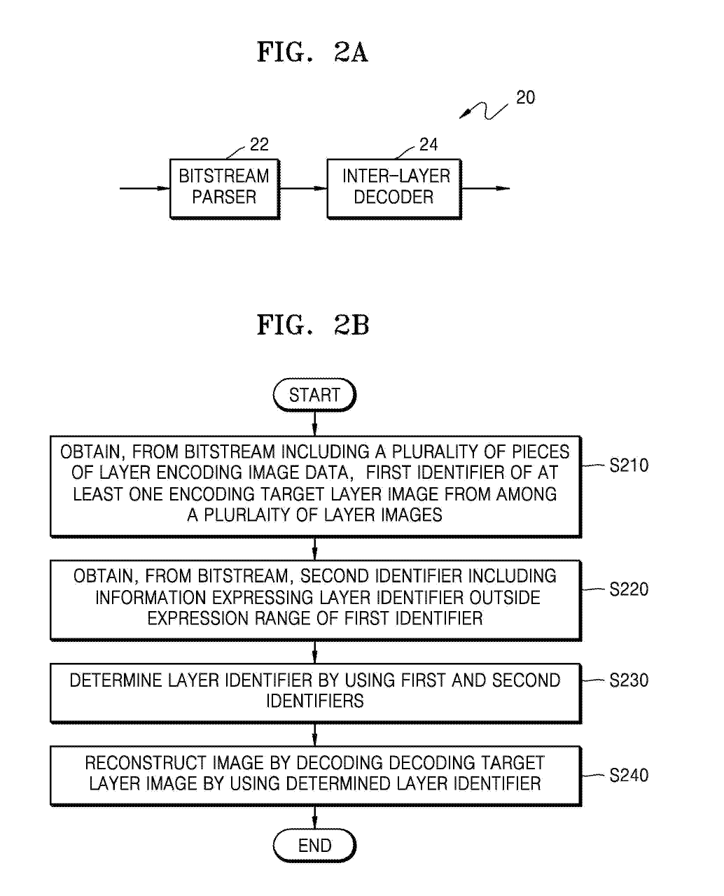

FIG. 2A is a block diagram of a video stream decoding apparatus 20 according to various exemplary embodiments. FIG. 2B is a flowchart of a video stream video decoding method according to various exemplary embodiments.

The video stream decoding apparatus 20 according to various exemplary embodiments include a bitstream parser 22 and the inter-layer decoder 24.

The video stream decoding apparatus 20 may receive a base layer stream and an enhancement layer stream. The video stream decoding apparatus 20 may receive the base layer stream including encoding data of base layer images and the enhancement layer stream including encoding data of enhancement layer images, according to a scalable video coding method.

The video stream decoding apparatus 20 may decode a plurality of layer streams according to a scalable video coding method. The video stream decoding apparatus 20 may reconstruct the base layer images by decoding the base layer stream and reconstruct the enhancement layer images by decoding the enhancement layer stream.

For example, a multi-view video may be encoded according to a scalable video coding method. For example, left view images may be reconstructed by decoding the base layer stream, and right view images may be reconstructed by decoding the enhancement layer stream. As another example, central view images may be reconstructed by decoding the base layer stream. Left view images may be reconstructed by further decoding a first enhancement layer stream in addition to the base layer stream. Right view images may be reconstructed by further decoding a second enhancement layer stream in addition to the base layer stream.

When a number of enhancement layers is at least three, first enhancement layer images of a first enhancement layer may be reconstructed from a first enhancement layer stream, and second enhancement layer images may be further reconstructed by further decoding a second enhancement layer stream. K-th enhancement layer images may be further reconstructed by further decoding a K-th enhancement layer stream in addition to the first enhancement layer stream.

The video stream decoding apparatus 20 may obtain encoded data of the base layer images and the enhancement layer images from the base layer stream and the enhancement layer stream, and may further obtain a motion vector generated via inter prediction and disparity information generated via inter-layer prediction.

For example, the video stream decoding apparatus 20 may decode inter predicted data according to layers, and decode inter-layer predicted data between a plurality of layers. Reconstruction may be performed via motion compensation and inter-layer decoding based on a coding unit or a prediction unit according to an exemplary embodiment.

Regarding each layer stream, images may be reconstructed by performing motion compensation for current image by referring to reconstructed images predicted via inter prediction of the same layer. Motion compensation is an operation of reconstructing a reconstructed image of a current image by composing a reference image determined by using a motion vector of the current image and a residual of the current image.

The video stream decoding apparatus 20 according to an exemplary embodiment may perform inter-layer decoding which references the base layer images so as to reconstruct the enhancement layer images predicted via inter-layer prediction. Inter-layer decoding is an operation of reconstructing a reconstructed image of a current image by composing a reference image of a different layer, which is determined by using disparity information of the current image, and a residual of the current image.

The video stream decoding apparatus 20 according to an exemplary embodiment may perform inter-layer decoding for reconstructing second enhancement layer images predicted by referring to first enhancement layer images.

The video stream decoding apparatus 20 performs decoding according to blocks of an image of each video. A block according to an exemplary embodiment may be, from among coding units according to a tree structure, a maximum coding unit, a coding unit, a prediction unit, or a transformation unit. For example, the video stream decoding apparatus 20 may reconstruct image sequences by decoding each layer stream based on blocks of a quad-tree structure determined according to the HEVC standards.

The inter-layer decoder 24 may obtain symbol data reconstructed via entropy decoding according to layers. The inter-layer decoder 24 may reconstruct quantized transformation coefficients of a residual by performing inverse quantization and inverse transformation by using the symbol data. The inter-layer decoder 24 according to another exemplary embodiment may receive a bitstream of the quantized transformation coefficients. The residual of images may be reconstructed as results of performing inverse quantization and inverse transformation on the quantized transformation coefficients.

The inter-layer decoder 24 according to various exemplary embodiments may reconstruct an image sequence according to layers by decoding a bitstream received according to layers.

The inter-layer decoder 24 may generate reconstructed images of an image sequence according to layers via motion compensation between the same layer images and via inter-layer prediction between different layer images.

Accordingly, the inter-layer decoder 24 according to various exemplary embodiments may decode an image sequence of each layer by referring to an image sequence of the same layer of an image sequence of a different layer, according to a prediction mode. For example, in an intra prediction mode, a current block may be reconstructed by using adjacent samples in the same image, and in an inter prediction mode, a current block may be reconstructed by referring to another image of the same layer. In an inter-layer prediction mode, a current block may be reconstructed by using a reference image to which the same POC as a current image is assigned from among images of a different layer.

The bitstream parser 22 according to an exemplary embodiment generates an NAL unit by parsing a bitstream. The bitstream parser 22 may include a receiver to perform functions of the receiver. For example, the bitstream parser 22 may generate an NAL unit by parsing a bitstream received from an encoding apparatus.

The bitstream parser 22 according to an exemplary embodiment may obtain, from the bitstream, a first identifier expressing a layer identifier of an encoding target layer image and a second identifier for expressing a layer identifier outside of an expression range of the first identifier. The bitstream parser 22 may obtain, from the bitstream, expansion indication information indicating that the second identifier includes information for expressing the layer identifier.

The bitstream parser 22 may obtain, from the bitstream, any one of a slice header, a parameter set header, and an NAL layer unit header, in which at least one of the first identifier and the second identifier is included. For example, the bitstream parser 22 may obtain an NAL unit header including the first and second identifiers, from the bitstream. The bitstream parser 22 may obtain the second identifier arranged at a next identifier location of the first identifier, according to an identifier arrangement order in the bitstream. The bitstream parser 22 may obtain the second identifier at a location of a temporal identifier.

The inter-layer decoder 24 according to an exemplary embodiment may reconstruct an image by decoding a base layer image and an enhancement layer image from encoding data of a plurality of layer images, which is included in the bitstream. The inter-layer decoder 24 may classify layer images by using a layer identifier (nuh_layer_id) assigned per encoding image of each layer, so as to decode each layer.

A layer identifier may be expressed by using a plurality of identifiers as described above with reference to an encoding apparatus according to an exemplary embodiment of the present disclosure. The inter-layer decoder 24 according to an exemplary embodiment of the present disclosure may determine a layer identifier by using a plurality of identifiers. For example, the inter-layer decoder 24 may determine a layer identifier by using an integer number of identifiers. For example, the inter-layer decoder 24 may determine a layer identifier by using two identifiers including first and second identifiers. A method of determining a layer identifier by using two identifiers will now be described. By describing the method of determining the layer identifier by using the two identifiers, a method of determining a layer identifier by using a plurality of identifiers will be described.

Hereinafter, a method of determining, by the inter-layer decoder 24 according to an exemplary embodiment of the present disclosure, a layer identifier by using first identifier and a second identifier will be described.

FIG. 3B is a diagram for describing a layer identifier expansion decoding method according to a first exemplary embodiment. In the first exemplary embodiment, the inter-layer decoder 24 may obtain a layer expansion indicator indicating that a layer identifier value is expressed by using a plurality of identifiers, and determine whether the layer identifier value is expressed by the plurality of identifiers by checking a value of the layer expansion indicator. For example, when the value of the layer expansion indicator is 1, the inter-layer decoder 24 may determine that the value of the layer identifier is expressed by using the plurality of identifiers.

The layer expansion indicator may be signaled from an encoding apparatus. The layer expansion indicator may be obtained from at least one of an NAL unit header, a parameter set, and a slice segment. For example, the layer expansion indicator may be obtained from a parameter set header or a slice segment header. A parameter set includes a video parameter set, a sequence parameter set, and a picture parameter set.

The inter-layer decoder 24 according to the first exemplary embodiment of the present disclosure may determine a layer identifier by assigning (a) bits obtained from a first identifier as MSBs of a layer identifier, and assigning (b) bits obtained from a second identifier as LSBs of the layer identifier. For example, a bit length of the (a) bits obtained from the first identifier and a bit length of the (b) bits obtained from the second identifier may be values pre-set between an encoding apparatus and a decoding apparatus. Alternatively, a maximum bit length N of the layer identifier and a length a of bits obtained from the first identifier may be pre-set between the encoding apparatus and the decoding apparatus, and thus the inter-layer decoder 24 may determine the layer identifier by assigning the (a) bits obtained from the first identifier as MSBs of the layer identifier and assigning (N-a) bits obtained from the second identifier as LSBs of the layer identifier. In this case, when N increases, the bit length of the second identifier may increase. An encoding apparatus and a decoding apparatus may be aware of a bit length for expressing a layer identifier, a bit length of an MSB assigned to the first identifier, and a bit length of an LSB assigned to the second identifier, and may encode and decode a value of the layer identifier by using the first and second identifiers, by using the bit lengths.

For example, it may be agreed between the encoding and decoding apparatuses that N is a maximum bit length for expressing a layer identifier and a is a bit length if the first identifier. For example, when 9 bits are required to express the maximum layer identifier and the bit length of the first identifier is 6 bits, 6 MSBs of the layer identifier may be assigned to the first identifier and the 3 LSBs of the layer identifier may be assigned to the second identifier to form the first and second identifiers.

When the value of the first or second identifier is a pre-set certain value, the inter-layer decoder 24 according to a second exemplary embodiment of the present disclosure may determine that the layer identifier is expressed by using a plurality of identifiers. Accordingly, in the second exemplary embodiment, generating and signaling of a layer expansion indicator of the first exemplary embodiment may be omitted.

For example, when the value of the first identifier is the pre-set certain value, the decoding apparatus may determine that the layer identifier is expressed by using a plurality of identifiers. For example, the inter-layer decoder 24 may determine the value of the layer identifier by performing calculation via a method pre-set by using the values of the first and second identifiers. For example, the inter-layer decoder 24 may determine the value of the layer identifier by using a sum of the values of the first and second identifiers.

According to another exemplary embodiment, when the first identifier has a maximum value expressible in the first identifier, the inter-layer decoder 24 may determine that the value of the layer identifier needs to be determined by using the first and second identifiers. For example, when the first identifier has a maximum value expressible in the first identifier, the inter-layer decoder 24 may determine the value of the layer identifier by adding the values of the first and second identifiers.

Similar to the above exemplary embodiment, when the value of the second identifier is a certain value, the inter-layer decoder 24 may determine the value of the layer identifier by using the values of the first and second identifiers.

In order for the inter-layer decoder 24 may obtain the first and second identifiers, locations of the first and second identifiers in an NAL unit and bit lengths of the first and second identifiers may be pre-set in the encoding and decoding apparatuses. For example, syntaxes for obtaining the first and second identifiers from the NAL unit may be pre-defined between the encoding and decoding apparatuses. Similarly, a syntax may be pre-defined, between the encoding and decoding apparatuses, with respect to the layer expansion indicator indicating that a layer identifier value is expressed by using the plurality of identifiers.

For example, the inter-layer decoder 24 may obtain, from the NAL unit, the first and second identifiers having bit sizes in independent integer sizes, by using the above syntaxes. For example, the first identifier may have a bit length of 6 bits and the second identifier may have a bit length of 3 bits. As another example, the first identifier may have a bit length of 6 bits and the second identifier may have a bit length of 4, 5, or 10 bits.

The inter-layer decoder 24 may obtain the first and second identifiers included in different data units by using the above syntaxes. For example, the first and second identifiers may be included, together or separately, in at least any one of an NAL unit header, a parameter set, and a slice segment. For example, the first and second identifiers may be included in a parameter set header or a slice segment header. Here, a parameter set may be a video parameter set, a sequence parameter set, or a picture parameter set.

For example, the first identifier may be included in a header of an NAL unit. For example, the first identifier may be a layer identifier included in a header of an NAL unit. Accordingly, the first identifier may be nuh_layer_id of 6 bits included in a header of an NAL unit.

The second identifier may also be included in a header of an NAL unit. For example, the second identifier may be a temporal identifier included in a header of an NAL unit. In an NAL unit header, three bits are assigned as a temporal identifier. For example, the second identifier may be temporal_id of 3 bits included in a header of an NAL unit.

When all layers are limited to having the same temporal identifier value in one access unit, the inter-layer decoder 24 may interpret a value of a temporal identifier of layers other than a base layer as another purpose. For example, the inter-layer decoder 24 may interpret a temporal identifier as additional bits for expressing a layer identifier. For example, when a temporal identifier of 3 bits is used as additional bits for expressing a layer identifier, a bit length of a layer identifier of 6 bits may be expanded to 9 bits. A layer identifier may have 512 values. In this case, the layer identifier may express 511 layers.

The inter-layer decoder 24 may use a flag in order to determine whether a layer identifier is expanded and expressed by using the second identifier. For example, the decoding apparatus may determine whether the layer identifier is expanded by using the second identifier, by checking a value of layer_id_extension_flag.

For example, when the value of layer_id_extension_flag is 1, the inter-layer decoder 24 may determine that all layers have the same temporal identifier value in a current access unit. Accordingly, the inter-layer encoder 12 may use a value of a temporal identifier of a base layer as a value of a temporal identifier of layers other than the base layer, and use a temporal identifier of the layers other than the base layer as a second identifier. For example, when the value of layer_id_extension_flag is 1, the inter-layer decoding apparatus may determine that temporal identifiers of all layers are synchronized.

According to another exemplary embodiment, the second identifier may be included as an additional bit in an NAL unit header. For example, the inter-layer decoder 24 according to an exemplary embodiment of the present disclosure may expand a size of an NAL unit header as much as the bit length of the second identifier, and include the second identifier in the NAL unit header.

According to another exemplary embodiment, the second identifier may be included in at least one of a video parameter set header, a sequence parameter set header, and a slice segment header, in a certain bit length.

The second identifier may be located at a next identifier location of the first identifier regarding an identifier arrangement order in a bitstream. For example, the first and second identifiers may both be included in an NAL unit header. For example, the first identifier may be a layer identifier included in an NAL unit header, and the second identifier may be a temporal identifier included in the NAL unit header.

Hereinafter, detailed operations of the video stream decoding apparatus 20 determining a layer identifier by using a plurality of identifiers will be described with reference to FIG. 2B.

First, a decoding apparatus obtains, from a bitstream including a base layer and enhancement layer encoding image data, a first identifier of at least one decoding target layer image form among a plurality of layer images, in operation S210. Then, the decoding apparatus obtains, from the bitstream, a second identifier including information expressing a layer identifier outside of an expression range of the first identifier, in operation S220.

Next, the decoding apparatus determines a layer identifier by using the first and second identifiers, in operation S230. For example, when a value of the first identifier is a maximum value expressible in the first identifier, the decoding apparatus may determine the layer identifier by using the first and second identifiers.

For example, when the first identifier has the maximum value, the decoding apparatus may determine that the value of the layer identifier is expressed by using the first and second identifiers. Accordingly, the decoding apparatus determines the value of the layer identifier by using the first and second identifiers according to a method pre-set with an encoding apparatus. According to an exemplary embodiment, the decoding apparatus may determine the value of the layer identifier by adding the values of the first and second identifiers. According to another exemplary embodiment, the decoding apparatus may simply determine the value of the second identifier as the value of the layer identifier.

According to another exemplary embodiment, the decoding apparatus may obtain, from the bitstream, expansion indication information indicating that the second identifier includes information for expressing the layer identifier, and determine whether to use the second identifier to determine the layer identifier according to a value of the expansion indication information.

For example, when the value of the expansion indication information is a pre-set value to indicate that the second identifier includes information for expressing the layer identifier, such as 0 or 1, the decoding apparatus may determine that the second identifier includes information for expressing the layer identifier. For example, the decoding apparatus may obtain MSBs of the layer identifier as much as a pre-set number of bits from the first identifier, and obtain LSBs of the layer identifier as much as a pre-set number of bits from the second identifier. For example, the second identifier may include LSBs of the layer identifier, which are not included in the first identifier.

The second identifier may be obtained from any one of a slice header, a parameter set header, and an NAL unit header. For example, the first and second identifiers may be obtained from an NAL unit header. For example, the second identifier may be obtained from a next identifier location of the first identifier with respect to an identifier arrangement order in the bitstream. For example, the second identifier may be a temporal identifier included in the bitstream.

Then, the decoding apparatus may reconstruct an image by decoding the decoding target layer image by using the determined layer identifier, in operation S240.

The decoding apparatus may obtain, from the bitstream, output layer information by using an expanded maximum layer identifier, and decode a target layer image by using the output layer information. The output layer information may be information of a layer to be decoded and output in an output layer set. For example, the decoding apparatus may obtain, from the bitstream, an identifier of a maximum layer in a video parameter set, obtain a number of bits assigned to the second identifier, and then determine an identifier of the expanded maximum layer by using the number of bits assigned to the second identifier and the maximum layer identifier.

The decoding apparatus may obtain inter-layer direct reference information according to a maximum number of expanded layers, and decode a target layer image by using the inter-layer direct reference information. For example, the decoding apparatus may obtain, from the bitstream, an identifier indicating a maximum layer number in a video parameter set, and obtain the number of bits assigned to the second identifier, thereby determining the maximum number of the expanded layers by using the identifier indicating the maximum layer number and the number of bits assigned to the second identifier.

The decoding apparatus may determine a temporal identifier value of the decoding target layer image according to a value of a temporal identifier of a base layer.

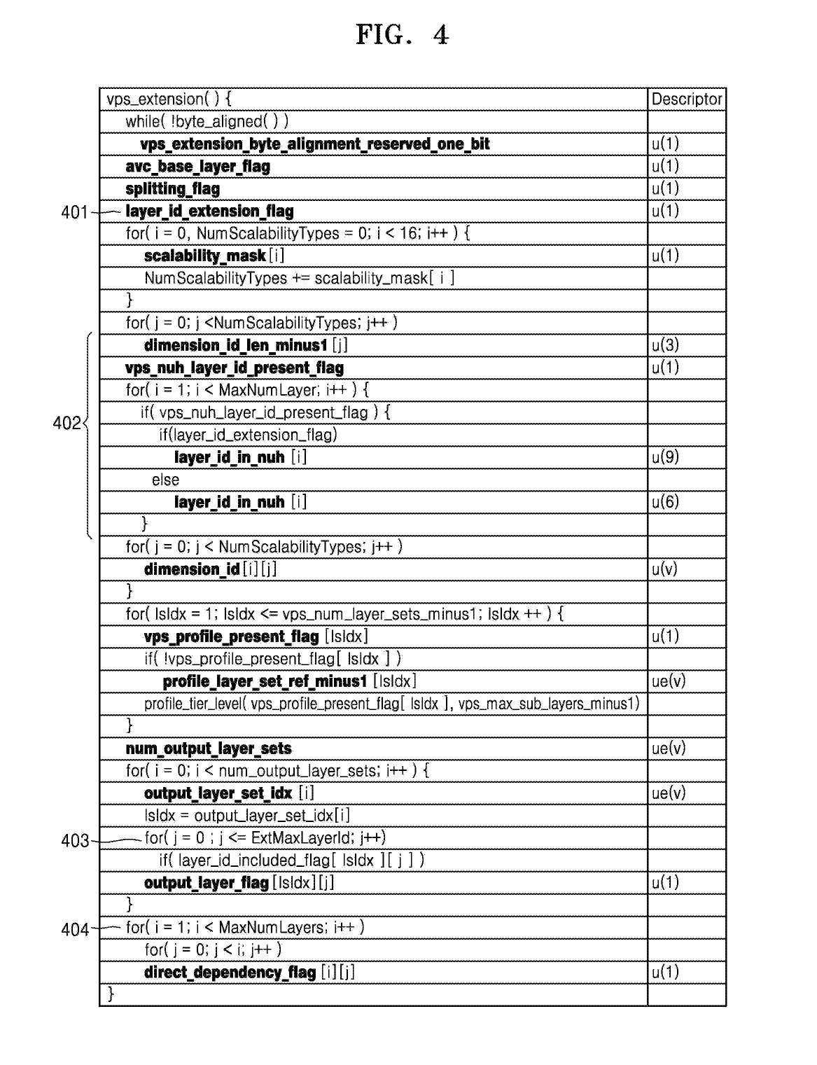

FIG. 4 illustrates a syntax for signaling a layer identifier by using a plurality of identifiers, according to an exemplary embodiment of the present disclosure. Hereinafter, the syntax for signaling a layer identifier by using a plurality of identifiers will be described with reference to FIG. 4.

When a value of layer_id_extension_flag 401 is 1, TemporalID of layers having nonzero nuh_layer_id has the same value as TemporalID of base layers of which nuh_layer_id is 0. For example, when layer_id_extension_flag is 1, nuh_temporal_id_plus1 is used as an additional bit of nuh_layer_id.

For example, when layer_id_extension_flag is 1 like a syntax region 402 obtaining a layer identifier of FIG. 4, nuh_temporal_id_plus1 is used as an additional bit of nuh_layer_id. A size of an identifier of layer_id_in_nuh is directed to be u(9), and a syntax may be defined such that 9 bits are used.

vps_nuh_layer_id_present_flag is a flag indicating that a layer identifier is provided through an identifier of layer_id_in_nuh in a video parameter set syntax.

layer_id_in_nuh[i] indicates a value of nuh_layer_id in a VCL NAL unit of an i-th layer.

As shown in a pseudo code in a following table, when a value of nuh_layer_id is 0, TemporalID is calculated according to nuh_temporal_id_plus1−1. When the value of nuh_layer_id is not 0, nuh_layer_id is calculated by subtracting 1 from nuh_temporal_id_plus1 of a base layer NAL unit such as 0.

```
TABLE 1
if(nuh_layer_id == 0)
  TemporalId = nuh_temporal_id_plus1 − 1;
else
  TemporalId = nuh_temporal_ id_plus1 of the base layer NAL unit of
which nuh_layer_id is equal to 0 in the same access unit − 1;
```

MaxNumLayers 404 that is a maximum layer number is calculated according to (vps_max_layers_minus1)*(1<<3-1)+1 when layer_id_extension_flag has a value of 1, as shown in a pseudo code in a following table. MaxNumLayers is calculated according to vps_max_layers_minus1+1 when layer_id_extension_flag does not have a value of 1. vps_max_layer_id denotes a maximum layer identifier in a video parameter set.

TABLE 2

```
if(layer_id_extension_flag)
  MaxNumLayers = (vps_max_layers_minus1) *(1<<3 −1) + 1;
else
  MaxNumLayers = vps_max_layers_minus1 + 1;
```

ExtLayerld that is an expanded layer identifier is calculated according to (nuh_layer_id−1)*(1<<3−1)+nuh_temporal_id_plus1 when layer_id_extension_flag is 1 and nuh_layer_id has a value larger than 0, and ExtLayerld has a value of nuh_layer_id when layer_id_extension_flag is not 1 or nuh_layer_id is 0.

```
TABLE 3
if(layer_id_extension_flag && nuh_layer_id > 0)
  ExtLayerId = (nuh_layer_id−1)*(1<<3 −1) + nuh_temporal_id_plus1;
else
  ExtLayerId = nuh_layer_id;
```

ExtMaxLayerld 403 that is an expanded maximum layer identifier is calculated according to vps_max_layer_id*(1<<3−1) when layer_id_extension_flag has a value of 1 as shown in a pseudo code in a following table. ExtMaxLayerld has a value of vps_max_layer_id when layer_id_extension_flag is not 1.

TABLE 4

```
if(layer_id_extension_flag)
  ExtMaxLayerId = vps_max_ layer_id *(1<<3 −1);
else
  ExtMaxLayerId = vps_max_layer_id;
```

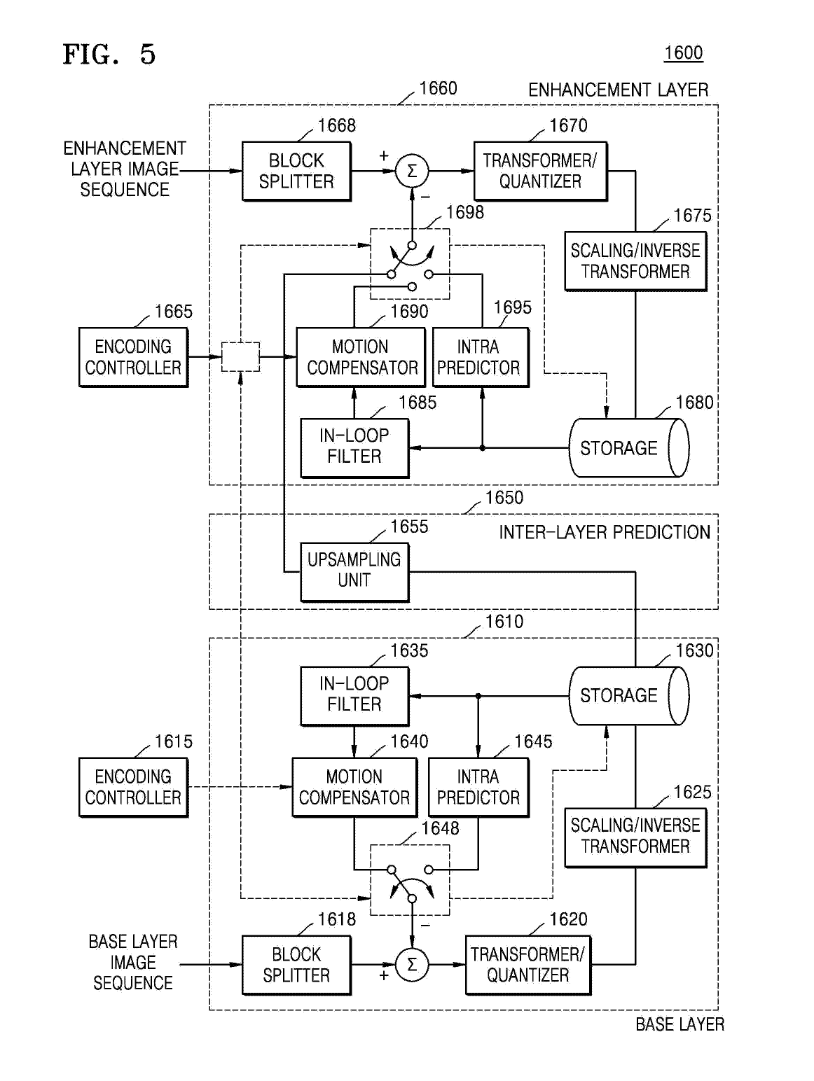

Hereinafter, an inter-layer prediction that may be performed by the encoder 12 of the video stream encoding apparatus 10 according to various exemplary embodiments will be described with reference to FIG. 5.

FIG. 5 illustrates an inter-layer prediction structure according to an exemplary embodiment.

An inter-layer encoding system 1600 includes a base layer encoder 1610, an enhancement layer encoder 1660, and an inter-layer predictor 1650 between the base layer encoder 1610 and the enhancement layer encoder 1660. The base layer encoder 1610 and the enhancement layer encoder 1660 may be included in the inter-layer encoder 12.

The base layer encoder 1610 receives and encodes a base layer image sequence according to images. The enhancement layer encoder 1660 receives and encodes an enhancement layer image sequence according to images. Overlapping operations of the base layer encoder 1610 and the enhancement layer encoder 1660 will be simultaneously described.

An input image (a low resolution image or a high resolution image) is split into a maximum coding unit, a coding unit, a prediction unit, or a transformation unit through a block splitter 1618 or 1668. In order to encode a coding unit output from the block splitter 1618 or 1668, intra prediction or inter prediction may be preformed according to prediction units of the coding unit. A prediction switch 1648 or 1698 may enable inter prediction to be performed by referencing a pre-reconstructed image output from a motion compensator 1640 or 1690 or intra prediction to be performed by using a neighboring prediction unit of a current prediction unit in a current input image output from an intra predictor 1645 or 1695, based on whether a prediction mode of a prediction unit is an intra prediction mode or an inter prediction mode. Residual information may be generated according to prediction units via inter prediction.

Residual information between a prediction unit and an adjacent image is input to a transformation/quantization unit 1620 or 1670 according to prediction units of a coding unit. The transformation/quantization unit 1620 or 1670 may output a quantized transformation coefficient by performing transformation and quantization according to transformation units, based on a transformation unit of a coding unit.

A scaling/inverse transformation unit 1625 or 1675 may generate residual information of a spatial domain by again performing scaling and inverse transformation on the quantized transformation coefficient according to transformation units of a coding unit. When the prediction switch 1648 or 1698 is controlled to point at an inter mode, a reconstructed image including a current prediction unit may be generated as the residual information is composed with a pre-reconstructed image or a neighboring prediction unit, and the reconstructed image may be stored in a storage unit 1630 or 1680. The reconstructed image may be transmitted to the intra predictor 1645 or 1695 or the motion compensator 1640 or 1690 according to a prediction mode of a prediction unit that is encoded next.

In detail, in an inter mode, an in-loop filtering unit 1635 or 1685 may perform, on a reconstructed image stored in the storage unit 1630 or 1680, at least one of deblocking filtering and sample adaptive offset (SAO) filtering according to coding units. At least one of deblocking filtering and SAO filtering may be performed on a coding unit and at least one of a prediction unit and a transformation unit included in the coding unit.

Deblocking filtering is filtering for easing a blocking phenomenon of a data unit, and SAO filtering is filtering for compensating for a pixel value that is transformed according to data encoding and decoding. Data filtered by the in-loop filtering unit 1635 or 1685 may be transmitted to the motion compensator 1640 or 1690 according to prediction units. Then, in order to encode a following coding unit output from the block splitter 1618 or 1668, residual information between a current reconstructed image and a following coding unit output from the motion compensator 1640 or 1690 and the block splitter 1618 or 1668 may be generated.

As such, the above encoding operation may be repeated according to coding units of an input image.

For inter-layer prediction, the enhancement layer encoder 1660 may reference a reconstructed image stored in the storage unit 1630 of the base layer encoder 1610. An encoding controller 1615 of the base layer encoder 1610 may control the storage unit 1630 of the base layer encoder 1610 to transmit a reconstructed image of the base layer encoder 1610 to the enhancement layer encoder 1660. In the inter-layer predictor 1650, an inter-layer filtering unit 1655 (e.g., an up-sampling unit, etc.) may perform deblocking filtering or SAO filtering on a base layer reconstructed image output from the storage unit 1630 of the base layer encoder 1610. When resolution of a base layer image and resolution of an enhancement layer image are different from each other, the inter-layer predictor 1650 may up-sample the base layer reconstructed image before transmitting the base layer reconstructed image to the enhancement layer encoder 1660. When inter-layer prediction is performed according to control of the prediction switch 1698 of the enhancement layer encoder 1660, inter-layer prediction may be performed on an enhancement layer image by referencing the base layer reconstructed image transmitted through the inter-layer predictor 1650.

In order to encode an image, various encoding modes may be set for a coding unit, a prediction unit, and a transformation unit. For example, a depth or split information (split flag) may be set as an encoding mode of a coding unit. A prediction mode, a partition type, intra direction information, or reference list information may be set as an encoding mode of a prediction unit. A transformation depth or split information may be set as an encoding mode of a transformation unit.

The base layer encoder 1610 may determine an encoding depth, a prediction mode, a partition type, an intra direction/reference list, and a transformation depth, which have highest encoding efficiency, based on results of performing encoding by applying various depths for a coding unit, various prediction modes, various partition types, various intra directions, and various reference lists for a prediction unit, and various transformation depths for a transformation unit. The encoding mode determined by the base layer encoder 1610 is not limited thereto.

The encoding controller 1615 of the base layer encoder 1610 may control each component such that one of various encoding modes is suitably applied thereto. In addition, the encoding controller 1615 may control the enhancement layer encoder 1660 to determine an encoding mode or residual information by referencing an encoding result of the base layer encoder 1610, for inter-layer encoding of the enhancement layer encoder 1660.

For example, the enhancement layer encoder 1660 may use an encoding mode of the base layer encoder 1610 as an encoding mode for an enhancement layer image, or may determine an encoding mode for an enhancement layer image by referencing an encoding mode of the base layer encoder 1610. The encoding controller 1615 of the base layer encoder 1610 may control a control signal of an encoding controller 1665 of the enhancement layer encoder 1660 to use a current encoding mode of the base layer encoder 1610 in order to determine a current encoding mode of the enhancement layer encoder 1660.

An inter-layer decoding system according to an inter-layer prediction method may be realized similarly to the inter-layer encoding system 1600 of FIG. 5 according to the inter-layer prediction method. In other words, the inter-layer decoding system of a multi-layer video may receive a base layer bitstream and an enhancement layer bitstream. A base layer decoder of the inter-layer decoding system may reconstruct base layer images by decoding the base layer bitstream. An enhancement layer decoder of the inter-layer decoding system may reconstruct enhancement layer images by decoding the enhancement layer bitstream by using a base layer reconstructed image and parsed encoding information.

When the encoder 12 of the video stream encoding apparatus 10 according to various exemplary embodiments performed inter-layer prediction, the decoder 26 of the video stream decoding apparatus 20 may reconstruct multi-layer images according to an inter-layer decoding system described above.

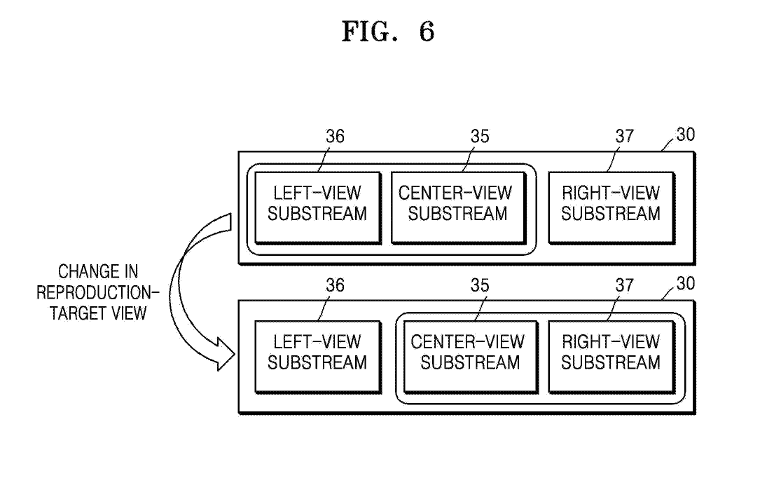

Hereinafter, exemplary embodiments of the video stream encoding apparatus 10 and the video stream decoding apparatus 20 applying an inter-layer prediction structure to a multi-view video will be described with reference to FIG. 6. Since an individual view video in an inter-view prediction structure of a multi-view video is assigned to one layer, the inter-view prediction structure may also be interpreted as an inter-layer prediction structure.

FIG. 6 illustrates an inter-layer prediction structure of a multi-view video stream.

A multi-view video stream 30 according to an exemplary embodiment includes a central view sub-stream 35, a left view sub-stream 36, and a right view sub-stream 38.

The central view sub-stream 35 includes a bitstream generated by encoding central view images. The left view sub-stream 36 includes a bitstream generated by encoding left view images. The right view sub-stream 37 includes a bitstream generated by encoding right view images.

In order to decode a video of desired viewpoints, only sub-streams of certain viewpoints may be extracted from the multi-view video stream 30, decoded, and reproduced without having to decode sub-streams of all viewpoints. In addition, since the multi-view video stream 30 includes image streams of a plurality of viewpoints, reproduction viewpoints may be selected.

For example, when a central view video and a left view video are selected to be reproduced, only the central view sub-stream 35 and the left view sub-stream 36 may be extracted and decoded from the multi-view video stream 30.

A viewpoint may be changed to reproduce the central view video and a right view video while reproducing the central view video and the left view video. In this case, the central view sub-stream 35 and the left view sub-stream 36 are extracted and decoded from the multi-view video stream 30, and after a reproduction viewpoint is changed, the central view sub-stream 35 and the right view sub-stream 37 may be extracted and decoded.

According to related technologies, a point where a reproduction viewpoint is changed is limited to a random access point, i.e., an RAP image, in a CRA image, BLA image, or an IDR image.

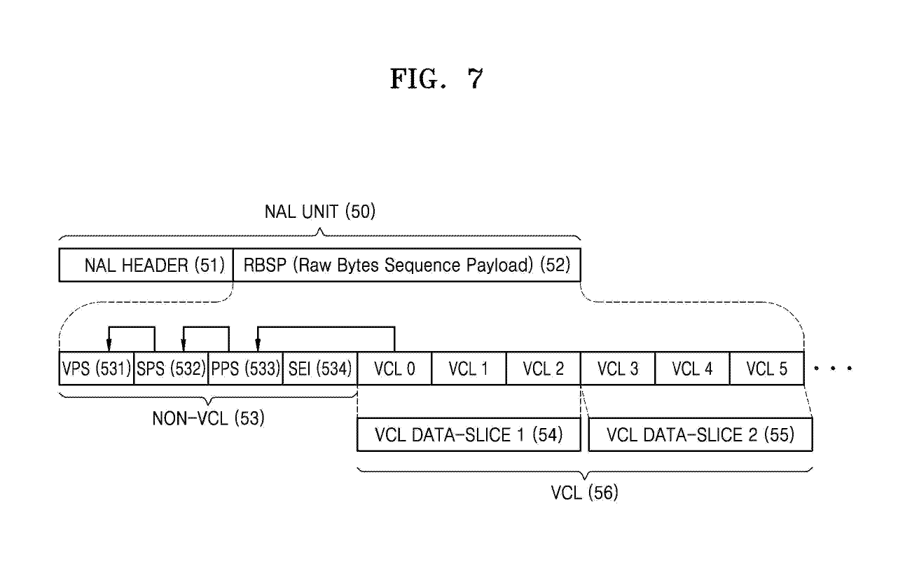

Hereinafter, various exemplary embodiments of the video stream encoding apparatus 10 and the video stream decoding apparatus 20 for signaling information about a changeable inter-layer prediction method will be described with reference to FIG. 7.

FIG. 7 illustrates a structure of an NAL unit.

The video stream encoding apparatus 10 may capsulate a video stream including encoded data and window-related information in a form of an NAL unit 50 such that the video stream is easily transmitted on a network. The NAL unit 50 includes an NAL header 51 and a raw bytes sequence payload (RBSP) 52.

The RBSP 52 may be distinguished into a non-video coding layer (non-VCL) NAL unit 53 and a VCL NAL unit 56. The VCL NAL unit 56 may include a sample value of video data or encoding data of the sample value. The non-VCL NAL unit 53 may include a parameter set including parameters related to video data included in the VCL NAL unit 56, and time information or additional data.

In detail, the non-VCL NAL unit 53 may include a VPS 531, an SPS 532, a picture parameter set (PPS) 533, and an SEI message 534. The VPS 531 may include parameters required to decode an entire video sequence, such as overall characteristics of currently encoded video sequences. The SPS 532 may include parameters required to decode a current video sequence. The PPS 533 may include parameters required to decode a current picture. The SEI message 534 may include additional information or time information that is useful in improving video decoding functionality but is not necessary for decoding.

The VCL NAL unit 56 may include actual encoded data of slices, such as VCL NAL units 54 including encoding data of slice 1 and VCL NAL units 55 including encoding data of slice 2.

One set of the SPS 532, the PPS 533, the SEI message 534, and the VCL NAL unit 56 indicates one video sequence, i.e., a video stream of single layer. The SPS 532 may refer to at least one parameter of the VPS 531. The PPS 533 may refer to at least one parameter of the SPS 532. The VCL NAL unit 56 may also refer to at least one parameter of the PPS 533.

For convenience of description, in the NAL unit 50 of FIG. 7, only one set of the SPS 532, the PPS 533, the SEI message 534, and the VCL NAL unit 56 is illustrated in a lower level of the VPS 531. However, when video sequences of a plurality of layers are assigned to the lower level of the VPS 531, an SPS, a PPS, an SEI message, and a VCL NAL unit for a next video sequence may be continued after the VCL NAL unit 56.

The video stream encoding apparatus 10 may generate the NAL unit 50 further including a VPS extension region for including additional information that is not included in the VPS 531. The video stream decoding apparatus 20 may obtain, from the VPS extension region of the NAL unit 50, RAP reference layer number information, non-RAP reference layer number information, RAP reference layer identification information, non-RAP reference layer identification information, and a plurality of pieces of standard use information.

The video stream encoding apparatus 10 of FIG. 1A may generate samples by performing intra prediction, inter prediction, inter-layer prediction, transformation, and quantization according to image blocks, and output a bitstream by performing entropy-encoding on the samples. In order to output a video encoding result, i.e., a base layer video stream and an enhancement layer video stream, the video stream encoding apparatus 10 according to an exemplary embodiment may operate in cooperation with an internal video encoding processor installed therein or an external video encoding processor so as to perform video encoding operations including transformation and quantization. The internal video encoding processor of the video stream encoding apparatus 10 according to an exemplary embodiment may be a separate processor, or alternatively, a video encoding apparatus, a central processing apparatus, or a graphic processing apparatus may include a video encoding processing module to perform the video encoding operations.

The video stream decoding apparatus 20 of FIG. 2A decodes a received base layer video stream and a received enhancement layer video stream. In other words, inverse quantization, inverse transformation, intra prediction, and motion compensation (inter-motion compensation and inter-layer disparity compensation) are performed according to image blocks with respect to the base layer video stream and the enhancement layer video stream to reconstruct samples of base layer images from the base layer video stream and samples of enhancement layer images from the enhancement layer video stream. In order to output a reconstructed image generated as a decoding result, the video stream decoding apparatus 20 according to an exemplary embodiment may operate in cooperation with an internal video decoding processor installed therein or an external video decoding processor so as to perform video restoration operations including inverse quantization, inverse transformation, and prediction/compensation. The internal video decoding processor of the video stream decoding apparatus 20 according to an exemplary embodiment may be a separate processor, or alternatively, a video decoding apparatus, a central processing apparatus, or a graphic processing apparatus may include a video decoding processing module to perform the video restoration operations.

In the video stream encoding apparatus 10 according to an exemplary embodiment and the video stream apparatus 20 according to an exemplary embodiment, as described above, video data may be split into coding units having a tree structure, and coding units, prediction units, and transformation units are used for inter layer prediction or inter prediction on the coding units. Hereinafter, a video encoding method and apparatus and a video decoding method and apparatus based on coding units and transformation units having a tree structure according to an exemplary embodiment will be described with reference to FIGS. 7 through 20.

In principle, during encoding/decoding for multi-layer video, encoding/decoding processes for base layer images and encoding/decoding processes for enhancement layer images are separately performed. That is, when inter-layer prediction is performed on a multi-layer video, encoding/decoding results of a single-layer video are referred to each other, but separate encoding/decoding processes are performed for respective single-layer videos.

For convenience of description, since a video encoding process and a video decoding process based on a coding unit of a tree structure, which will be described with reference to FIGS. 7 through 20, are performed on a single-layer video, inter prediction and motion compensation will be described. However, as described with reference to FIGS. 1A through 7, inter-layer prediction and compensation between base view images and enhancement layer images are performed to encode/decode a video stream.

Accordingly, in order for the inter-layer encoder 12 of video stream encoding apparatus 10 according to an exemplary embodiment to encode a multi-layer video based on coding units having a tree structure, the video stream encoding apparatus 10 may include as many video encoding apparatuses 100 of FIG. 8 as the number of layers of the multi-layer video so as to perform video encoding according to each single-layer video, thereby controlling each video encoding apparatus 100 to encode an assigned single-layer video. The video stream encoding apparatus 10 may perform inter-view prediction by using an encoding result of individual single views of each video encoding apparatus 100. Accordingly, the encoder 12 of the video stream encoding apparatus 10 may generate a base view video stream and an enhancement layer video stream, which include encoding results according to layers.

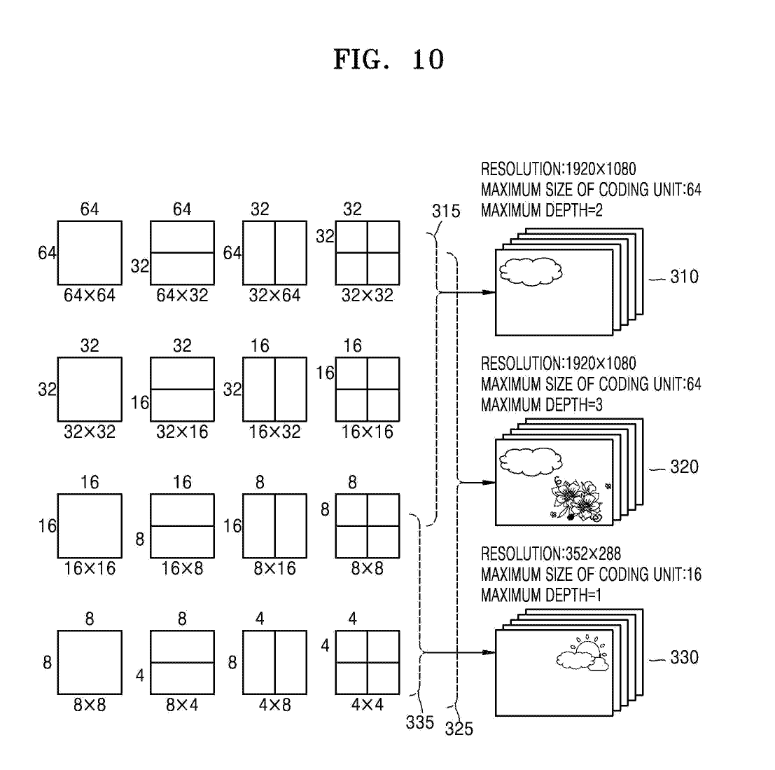

Similarly, in order for the decoder 26 of the video stream decoding apparatus 20 according to an exemplary embodiment to decode a multi-layer video based on coding units having a tree structure, the video stream decoding apparatus 20 may include as many video decoding apparatuses 200 of FIG. 9 as the number of layers of the multi-layer video so as to perform video decoding according to layers with respect to a received base layer video stream and a received enhancement layer video stream, thereby controlling each video decoding apparatus 200 to decode an assigned single-layer video. The video stream decoding apparatus 200 may perform inter-layer compensation by using a decoding result of individual single layer of each video decoding apparatus 200. Accordingly, the decoder 26 of the video stream decoding apparatus 20 may generate base layer images and enhancement layer images, which are reconstructed according to layers.

FIG. 8 is a block diagram of a video encoding apparatus 100 based on coding units according to a tree structure, according to an exemplary embodiment of the present disclosure.

The video encoding apparatus 100 according to an exemplary embodiment involving video prediction based on coding units according to a tree structure includes a maximum coding unit splitter 110, a coding unit determiner 120 and an output unit 130 (e.g., an output, etc.). Hereinafter, for convenience of description, the video encoding apparatus 10 according to an exemplary embodiment involving video prediction based on coding units according to a tree structure will be abbreviated to the ‘video encoding apparatus 100’.

The maximum coding unit splitter 110 may split a current picture based on a maximum coding unit that is a coding unit having a maximum size for a current picture of an image. If the current picture is larger than the maximum coding unit, image data of the current picture may be split into the at least one maximum coding unit. The maximum coding unit according to an exemplary embodiment may be a data unit having a size of 32×32, 64×64, 128×128, 256×256, etc., wherein a shape of the data unit is a square having a width and length in squares of 2.

A coding unit according to an exemplary embodiment may be characterized by a maximum size and a depth. The depth denotes the number of times the coding unit is spatially split from the maximum coding unit, and as the depth increases, deeper coding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit increases, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split, may be predetermined.

The coding unit determiner 120 encodes at least one split region obtained by splitting a region of the maximum coding unit according to depths, and determines a depth to output a finally encoded image data according to the at least one split region. In other words, the coding unit determiner 120 determines a coded depth by encoding the image data in the deeper coding units according to depths, according to the maximum coding unit of the current picture, and selecting a depth having the least encoding error. The determined coded depth and the encoded image data according to the determined coded depth are output to the output unit 130.

The image data in the maximum coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the number of coding units increases. Even if coding units correspond to the same depth in one maximum coding unit, it is determined whether to split each of the coding units corresponding to the same depth to a lower depth by measuring an encoding error of the image data of the each coding unit, separately. Accordingly, even when image data is included in one maximum coding unit, the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 according to an exemplary embodiment may determine coding units having a tree structure included in the maximum coding unit. The ‘coding units having a tree structure’ according to an exemplary embodiment include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to the number of splitting times from a maximum coding unit to a minimum coding unit. A first maximum depth according to an exemplary embodiment may denote the total number of splitting times from the maximum coding unit to the minimum coding unit. A second maximum depth according to an exemplary embodiment may denote the total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, depth levels of depths 0, 1, 2, 3, and 4 exist, and thus the first maximum depth may be set to 4, and the second maximum depth may be set to 5.

Prediction encoding and transformation may be performed according to the maximum coding unit. The prediction encoding and the transformation are also performed based on the deeper coding units according to a depth equal to or depths less than the maximum depth, according to the maximum coding unit.

Since the number of deeper coding units increases whenever the maximum coding unit is split according to depths, encoding, including the prediction encoding and the transformation, is performed on all of the deeper coding units generated as the depth increases. For convenience of description, the prediction encoding and the transformation will now be described based on a coding unit of a current depth, in a maximum coding unit.

The video encoding apparatus 100 according to an exemplary embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the maximum coding unit, the prediction encoding may be performed based on a coding unit corresponding to a coded depth according to an exemplary embodiment, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type according to an exemplary embodiment include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. The skip mode may be performed only on the partition of 2N×2N. The encoding is independently performed on one prediction unit in a coding unit, thereby selecting a prediction mode having a least encoding error.

The video encoding apparatus 100 according to an exemplary embodiment may also perform the transformation on the image data in a coding unit based not only on the coding unit for encoding the image data, but also based on a data unit that is different from the coding unit. In order to perform the transformation in the coding unit, the transformation may be performed based on a transformation unit having a size smaller than or equal to the coding unit. For example, the transformation unit may include a data unit for an intra mode and a transformation unit for an inter mode.

The transformation unit in the coding unit may be recursively split into smaller sized regions in a manner similar to that in which the coding unit is split according to the tree structure, according to an exemplary embodiment. Thus, residual data in the coding unit may be split according to the transformation unit having the tree structure according to transformation depths.

A transformation depth indicating the number of splitting times to reach the transformation unit by splitting the height and width of the coding unit may also be set in the transformation unit according to an exemplary embodiment. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Encoding information according to coding units corresponding to a coded depth requires not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

Coding units according to a tree structure in a maximum coding unit and methods of determining a prediction unit/partition, and a transformation unit, according to exemplary embodiments, will be described in detail later with reference to FIGS. 10 through 20.

The coding unit determiner 120 may measure an encoding error of deeper coding units according to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depth may include information about the coded depth, about the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, the current coding unit is encoded, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. A coded depth of the image data of the maximum coding unit may be different according to locations since the image data is hierarchically split according to depths, and thus information about the coded depth and the encoding mode may be set for the image data.

Accordingly, the output unit 130 according to an exemplary embodiment may assign encoding information about a corresponding coded depth and an encoding mode to at least one of the coding unit, the prediction unit, and a minimum unit included in the maximum coding unit.

The minimum unit according to an exemplary embodiment is a square data unit obtained by splitting the minimum coding unit constituting the lowermost depth by 4. Alternatively, the minimum unit according to an exemplary embodiment may be a maximum square data unit that may be included in all of the coding units, prediction units, partition units, and transformation units included in the maximum coding unit.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The output unit 130 may encode and output reference information related to prediction, prediction information, and slice type information.

In the video encoding apparatus 100 according to the simplest exemplary embodiment, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. The coding unit with the current depth having a size of 2N×2N may include a maximum of 4 of the coding units with the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Since encoding may be performed on each maximum coding unit by using any one of various prediction modes and transformations, an optimum encoding mode may be determined considering characteristics of the coding unit of various image sizes.

Thus, if an image having a high resolution or a large data amount is encoded in a fixed size macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100 according to an exemplary embodiment, image compression efficiency may be increased since a coding unit is adjusted while considering characteristics of an image while increasing a maximum size of a coding unit while considering a size of the image.

The video stream encoding apparatus 10 described above with reference to FIG. 1A may include as many video encoding apparatuses 100 as the number of layers, in order to encode single-layer images according to layers of a multi-layer video. For example, the base layer encoder 12 may include one video encoding apparatus 100 and the enhancement layer encoder 14 may include as many video encoding apparatuses 100 as the number of layers.

When the video encoding apparatus 100 encodes base layer images, the coding unit determiner 120 may determine, for each maximum coding unit, a prediction unit for inter-prediction according to coding units having a tree structure, and perform inter-prediction according to prediction units.

Even when the video encoding apparatus 100 encodes enhancement layer images, the coding unit determiner 120 may determine, for each maximum coding unit, coding units and prediction units having a tree structure, and perform inter-prediction according to prediction units.

FIG. 9 is a block diagram of the video decoding apparatus 200 based on coding units according to a tree structure, according to various exemplary embodiments.

The video decoding apparatus 200 according to an exemplary embodiment that involves video prediction based on coding units having a tree structure includes a receiver 210, an image data and encoding information extractor 220, and an image data decoder 230. For convenience of description, the video decoding apparatus 200 according to an exemplary embodiment that involves video prediction based on coding units having a tree structure will be abbreviated to the ‘video decoding apparatus 200’.

Definitions of various terms, such as a coding unit, a depth, a prediction unit, a transformation unit, and information about various encoding modes, for decoding operations of the video decoding apparatus 200 according to an exemplary embodiment are identical to those described with reference to FIG. 8 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture, a sequence parameter set, or a picture parameter set.

The image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transformation unit. Splitting information according to depths may be extracted as the information about the coded depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100 according to an exemplary embodiment, repeatedly performs encoding for each deeper coding unit according to depths according to each maximum coding unit. Accordingly, the video decoding apparatus 200 may reconstruct an image by decoding the image data according to a coded depth and an encoding mode that generates the minimum encoding error.

Since encoding information according to an exemplary embodiment about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. If information about a coded depth and encoding mode of a corresponding maximum coding unit is recorded according to predetermined data units, the predetermined data units to which the same information about the coded depth and the encoding mode is assigned may be inferred to be the data units included in the same maximum coding unit.

The image data decoder 230 may reconstruct the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include a prediction including intra prediction and motion compensation, and an inverse transformation.

The image data decoder 230 may perform intra prediction or motion compensation according to a partition and a prediction mode of each coding unit, based on the information about the partition type and the prediction mode of the prediction unit of the coding unit according to coded depths.

In addition, the image data decoder 230 may read information about a transformation unit according to a tree structure for each coding unit so as to perform inverse transformation based on transformation units for each coding unit, for inverse transformation for each maximum coding unit. Via the inverse transformation, a pixel value of a spatial region of the coding unit may be reconstructed.

The image data decoder 230 may determine a coded depth of a current maximum coding unit by using split information according to depths. If the split information indicates that image data is no longer split in the current depth, the current depth is a coded depth. Accordingly, the image data decoder 230 may decode encoded data in the current maximum coding unit by using the information about the partition type of the prediction unit, the prediction mode, and the size of the transformation unit for each coding unit corresponding to the coded depth.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

The decoder 12 of the video stream encoding apparatus 10 described above with reference to FIG. 1A may include as many image data decoders 230 as the number of layers, so as to generate a reference image for inter prediction according to layers of a multi-layer video.

The decoder 26 of the video stream decoding apparatus 20 described above with reference to FIG. 2A may include the number of video decoding apparatuses 200 as much as the number of layers, so as to reconstruct base layer images and enhancement layer images by decoding a received base layer image stream and a received enhancement layer image stream.

When the base layer image stream is received, the image data decoder 230 of the video decoding apparatus 200 may split samples of base layer images extracted from the base layer image stream by the image data and encoding information extractor 220 into coding units having a tree structure. The image data decoder 230 may reconstruct the base layer images by performing motion compensation according to prediction units for inter prediction, on the coding units having the tree structure obtained by splitting the samples of the base layer images.

When the enhancement layer image stream is received, the image data decoder 230 of the video decoding apparatus 200 may split samples of enhancement layer images extracted from the enhancement layer image stream by the image data and encoding information extractor 220 into coding units having a tree structure. The image data decoder 230 may reconstruct the enhancement layer images by performing motion compensation according to prediction units for inter prediction, on the coding units obtained by splitting the samples of the enhancement layer images.

Thus, the video decoding apparatus 200 may obtain information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded.

Accordingly, even if image data has high resolution and a large amount of data, the image data may be efficiently decoded and reconstructed by using a size of a coding unit and an encoding mode, which are adaptively determined according to characteristics of the image data, by using information about an optimum encoding mode received from an encoder.

FIG. 10 is a diagram for describing a concept of coding units according to various exemplary embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 10 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a maximum coding unit having a long axis size of 64, and coding units having long axis sizes of 32 and 16 since depths are increased to two layers by splitting the maximum coding unit twice. Since the maximum depth of the video data 330 is 1, coding units 335 of the video data 330 may include a maximum coding unit having a long axis size of 16, and coding units having a long axis size of 8 since depths are increased to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are increased to 3 layers by splitting the maximum coding unit three times. As a depth increases, detailed information may be precisely expressed.

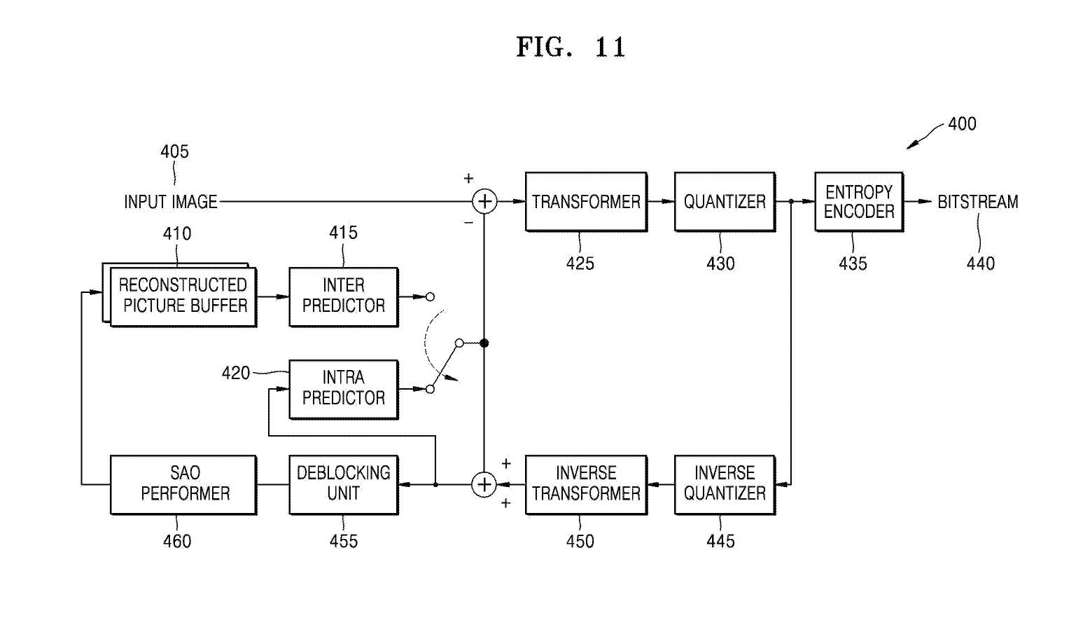

FIG. 11 is a block diagram of an image encoder 400 based on coding units, according to an exemplary embodiment.

The image encoder 400 according to an exemplary embodiment performs operations necessary for encoding image data in the picture decoder 120 of the video encoding apparatus 100. In other words, an intra predictor 420 performs intra prediction on coding units in an intra mode according to prediction units, from among a current frame 405, and an inter predictor 415 performs inter prediction on coding units in an inter mode by using a current image 405 and a reference image obtained from a reconstructed picture buffer 410 according to prediction units. The current image 405 may be split into maximum coding units and then the maximum coding units may be sequentially encoded. In this regard, the maximum coding units that are to be split into coding units having a tree structure may be encoded.

Residue data is generated by removing prediction data regarding coding units of each mode that is output from the intra predictor 420 or the inter predictor 415 from data regarding encoded coding units of the current image 405, and is output as a quantized transformation coefficient according to transformation units through a transformer 425 and a quantizer 430. The quantized transformation coefficient is reconstructed as the residue data in a space domain through an inverse quantizer 445 and an inverse transformer 450. The reconstructed residue data in the space domain is added to prediction data for coding units of each mode that is output from the intra predictor 420 or the inter predictor and thus is reconstructed as data in a space domain for coding units of the current image 405. The reconstructed data in the space domain is generated as reconstructed images through a de-blocking unit 455 and an SAO performer 460 and the reconstructed images are stored in the reconstructed picture buffer 410. The reconstructed images stored in the reconstructed picture buffer 410 may be used as reference images for inter prediction of another image. The transformation coefficient quantized by the transformer 425 and the quantizer 430 may be output as a bitstream 440 through an entropy encoder 435.

In order for the image encoder 400 according to an exemplary embodiment to be applied in the video encoding apparatus 100, all elements of the image encoder 400, i.e., the inter predictor 415, the intra predictor 420, the transformer 425, the quantizer 430, the entropy encoder 435, the inverse quantizer 445, the inverse transformer 450, the de-blocking unit 455, and the SAO performer 460, perform operations based on each coding unit among coding units having a tree structure according to each maximum coding unit.

Specifically, the intra predictor 420 and the inter predictor 415 may determine a partition mode and a prediction mode of each coding unit among the coding units having a tree structure in consideration of a maximum size and a maximum depth of a current maximum coding unit, and the transformer 425 may determine whether to split a transformation unit having a quad tree structure in each coding unit among the coding units having a tree structure.

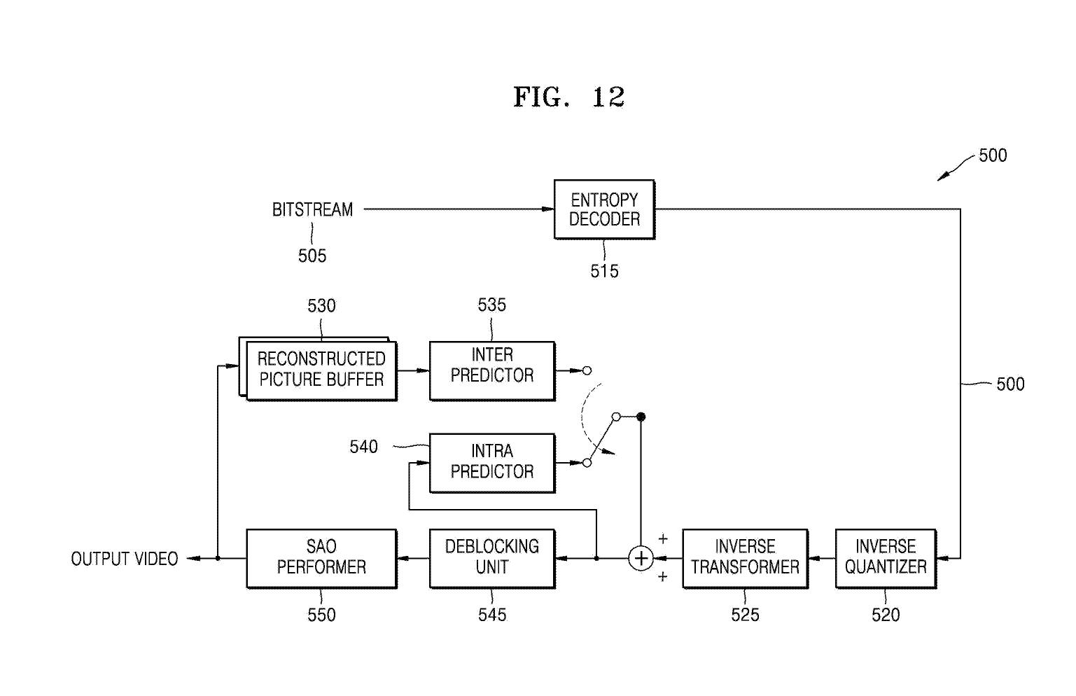

FIG. 12 is a block diagram of an image decoder 500 based on coding units, according to an exemplary embodiment.

An entropy decoder 515 parses encoded image data to be decoded and encoding information required for decoding from a bitstream 505. The encoded image data is a quantized transformation coefficient from which residue data is reconstructed by an inverse quantizer 520 and an inverse transformer 525.

An intra predictor 540 performs intra prediction on coding units in an intra mode according to each prediction unit. An inter predictor 535 performs inter prediction on coding units in an inter mode from among the current image for each prediction unit by using a reference image obtained from a reconstructed picture buffer 530.

Prediction data and residue data regarding coding units of each mode, which passed through the intra predictor 540 and the inter predictor 535, are summed, and thus data in a space domain regarding coding units of the current image 405 may be reconstructed, and the reconstructed data in the space domain may be output as a reconstructed image 560 through a de-blocking unit 545 and an SAO performer 550. Reconstructed images stored in the reconstructed picture buffer 530 may be output as reference images.

In order to decode the image data in the image data decoder 230 of the video decoding apparatus 200, operations after the entropy decoder 515 of the image decoder 500 according to an exemplary embodiment may be performed.

In order for the image decoder 500 to be applied in the video decoding apparatus 200 according to an exemplary embodiment, all elements of the image decoder 500, i.e., the entropy decoder 515, the inverse quantizer 520, the inverse transformer 525, the inter predictor 535, the de-blocking unit 545, and the SAO performer 550 may perform operations based on coding units having a tree structure for each maximum coding unit.

In particular, the intra predictor 540 and the inter predictor 535 may determine a partition and a prediction mode for each of the coding units having a tree structure, and the inverse transformer 525 may determine whether to split a transformation unit having a quad tree structure for each of the coding units.

The encoding operation of FIG. 11 and the decoding operation of FIG. 12 respectively describe video stream encoding and decoding operations in a single layer. Thus, if the encoder 12 of FIG. 1A encodes video streams of two or more layers, the image encoder 400 may be included for each layer. Similarly, if the decoder 26 of FIG. 2A decodes video streams of two or more layers, the image decoder 500 may be included for each layer.

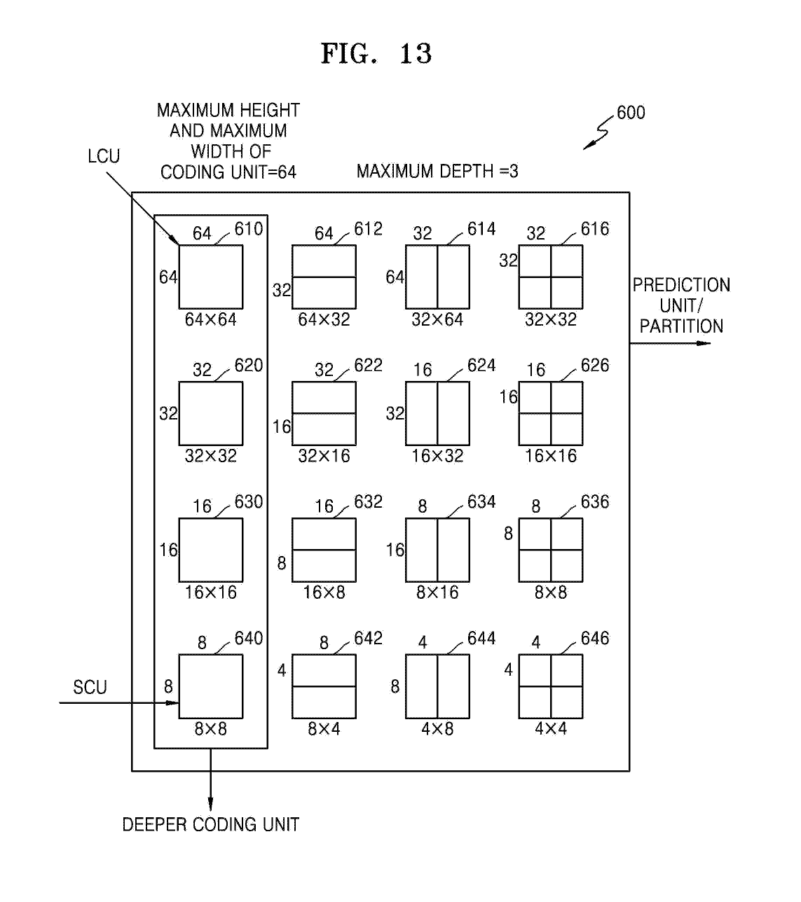

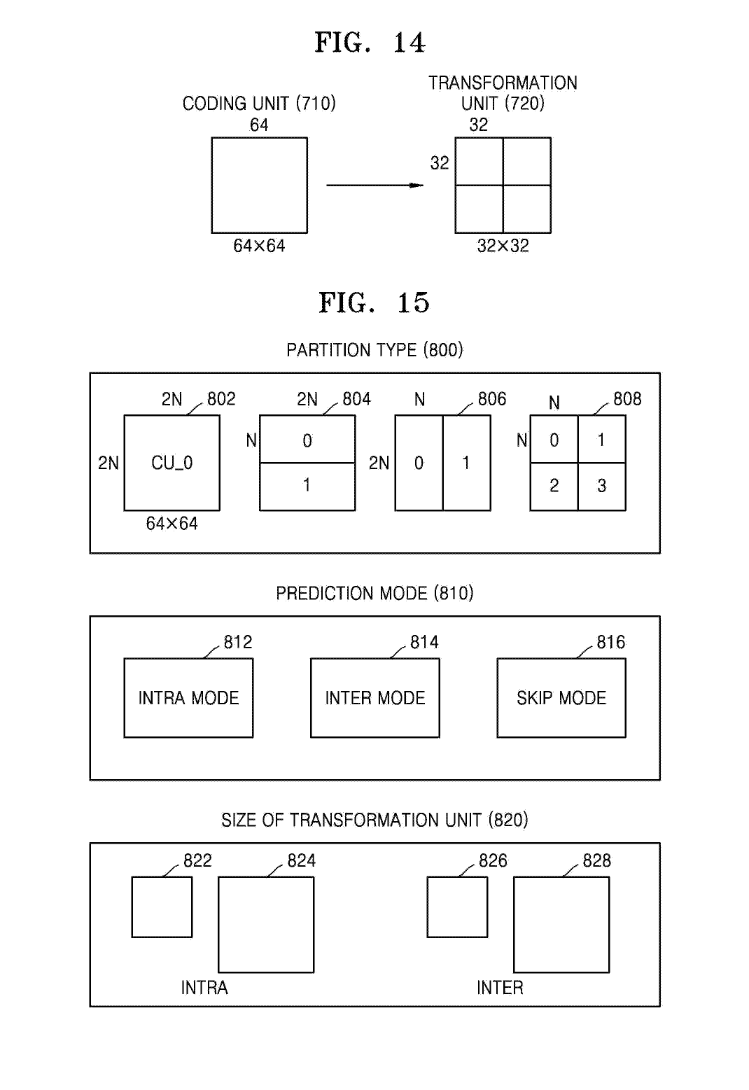

FIG. 13 is a diagram illustrating deeper coding units according to depths, and partitions, according to various exemplary embodiments.

The video encoding apparatus 100 according to an exemplary embodiment and the video decoding apparatus 200 according to an exemplary embodiment use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units according to an exemplary embodiment, the maximum height and the maximum width of the coding units are each 64, and the maximum depth is 3. In this case, the maximum depth refers to a total number of times the coding unit is split from the maximum coding unit to the minimum coding unit. Since a depth increases along a vertical axis of the hierarchical structure 600 of coding units according to an exemplary embodiment, a height and a width of the deeper coding unit are each split. A prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth increases along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having a size of 8×8 and a depth of 3 is a minimum coding unit.

The prediction unit and the partitions of a coding unit are arranged along the horizontal axis according to each depth. In other words, if the coding unit 610 having a size of 64×64 and a depth of 0 is a prediction unit, the prediction unit may be split into partitions include in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

In order to determine the at least one coded depth of the coding units constituting the maximum coding unit 610, the coding unit determiner 120 of the video encoding apparatus 100 according to an exemplary embodiment performs encoding for coding units corresponding to each depth included in the maximum coding unit 610.

A number of deeper coding units according to depths including data in the same range and the same size increases as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth increases along the vertical axis of the hierarchical structure 600. A depth and a partition having the minimum encoding error in the coding unit 610 may be selected as the coded depth and a partition type of the coding unit 610.

FIG. 14 is a diagram for describing a relationship between a coding unit and transformation units, according to various exemplary embodiments.

The video encoding apparatus 100 according to an exemplary embodiment or the video decoding apparatus 200 according to an exemplary embodiment encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 according to an exemplary embodiment or the video decoding apparatus 200 according to an exemplary embodiment, if a size of a coding unit 710 is 64×64, transformation may be performed by using a transformation units 720 having a size of 32×32.

Data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 15 is a diagram for describing encoding information of coding units corresponding to a coded depth, according to various exemplary embodiments.

The output unit 130 of the video encoding apparatus 100 according to an exemplary embodiment may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 according to an exemplary embodiment may extract and use the information 800, 810, and 820 for decoding, according to each deeper coding unit.

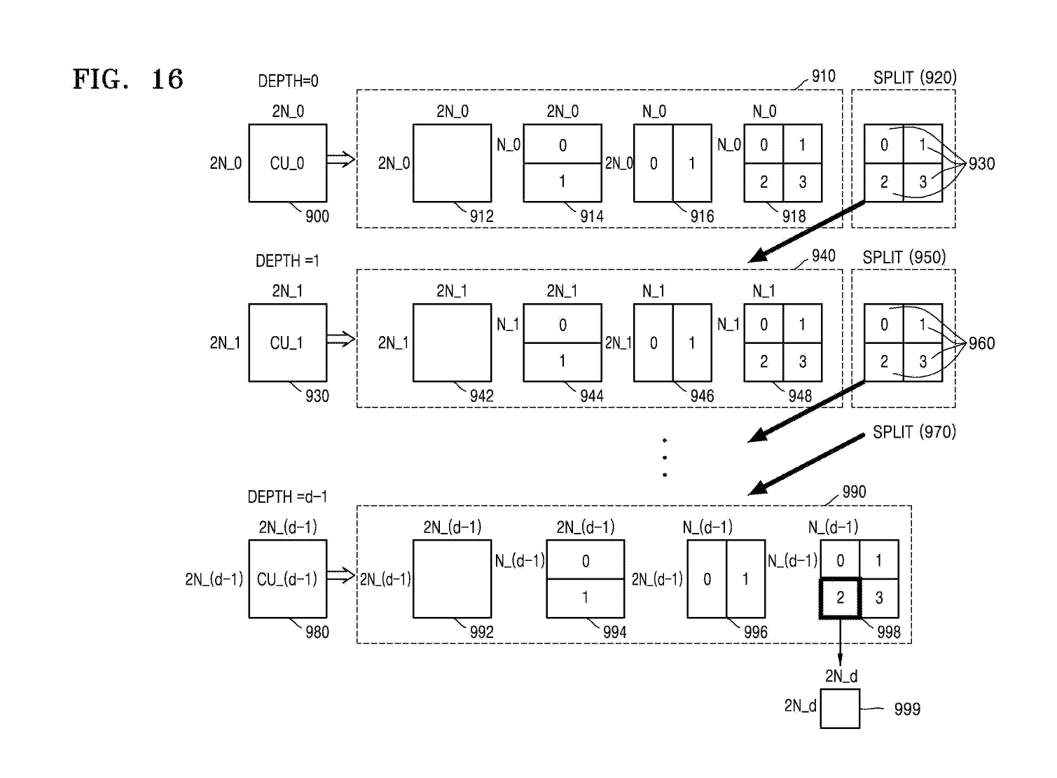

FIG. 16 is a diagram of deeper coding units according to depths, according to various exemplary embodiments.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is smallest in one of the partition types 912 through 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d−1, and split information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 has the minimum encoding error, since a maximum depth is d, a coding unit CU_(d−1) having a depth of d−1 is no longer split to a lower depth, and a coded depth for the coding units constituting a current maximum coding unit 900 is determined to be d−1 and a partition type of the current maximum coding unit 900 may be determined to be N_(d−1)×N_(d−1). Since the maximum depth is d, split information for a coding unit 952 having a depth of d−1 is not set.

A data unit 999 may be a ‘minimum unit’ for the current maximum coding unit. A minimum unit according to an exemplary embodiment may be a square data unit obtained by splitting a minimum coding unit having a lowermost coded depth by 4. By performing the encoding repeatedly, the video encoding apparatus 100 according to an exemplary embodiment may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Since a coding unit is split from a depth of 0 to a coded depth, only split information of the coded depth is set to 0, and split information of depths excluding the coded depth is set to 1.

The image data and encoding information extractor 220 of the video decoding apparatus 200 according to an exemplary embodiment may extract and use the information about the coded depth and the prediction unit of the coding unit 900 to decode the partition 912. The video decoding apparatus 200 according to an exemplary embodiment may determine a depth, in which split information is 0, as a coded depth by using split information according to depths, and use information about an encoding mode of the corresponding depth for decoding.

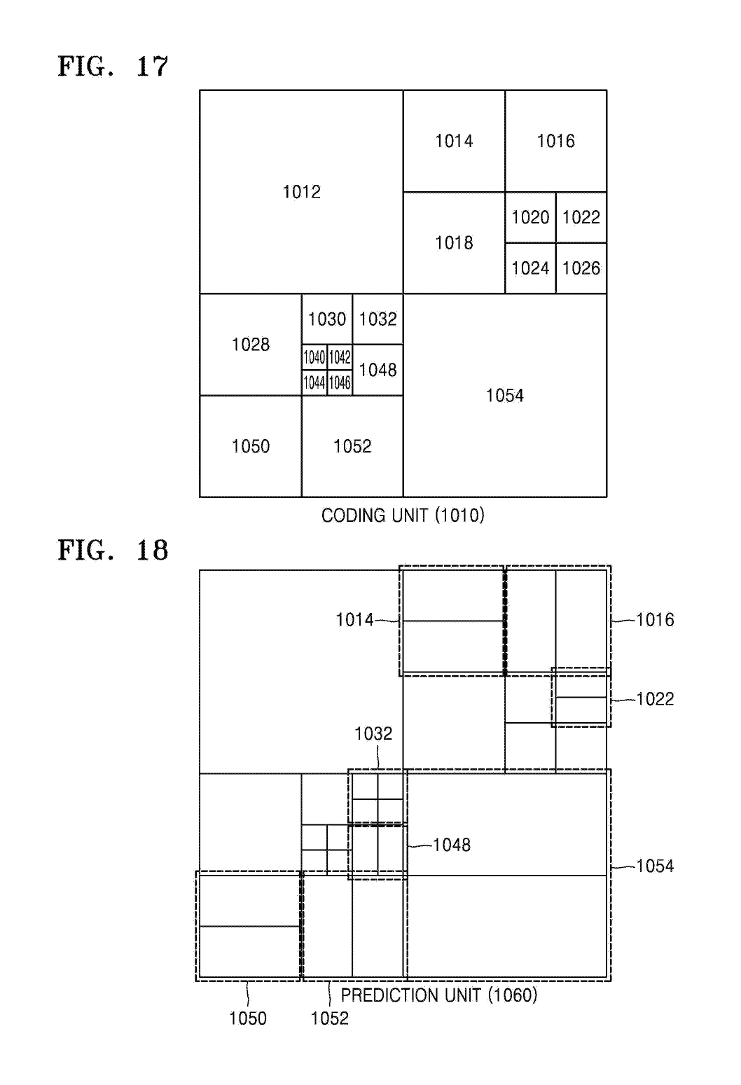

FIGS. 17 through 19 are diagrams for describing a relationship between coding units, prediction units, and transformation units, according to various exemplary embodiments.

Coding units 1010 are coding units having a tree structure, corresponding to coded depths determined by the video encoding apparatus 100 according to an exemplary embodiment, in a maximum coding unit. Prediction units 1060 are partitions of prediction units of each of the coding units 1010, and transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. The coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 according to an exemplary embodiment may perform intra prediction, motion estimation, motion compensation, transformation, and inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 5 shows the encoding information that may be set by the video encoding and decoding apparatuses 100 and 200 according to an exemplary embodiment.

TABLE 5

| | | | | | Split |
|---|---|---|---|---|---|
| Split Information 0 | | | | | Information |
| (Encoding on Coding Unit having Size of 2N × 2N and Current Depth of d) | | | | | 1 |
| Prediction | Partition Type | | Size of Transformation Unit | | Repeatedly |
| Mode | | | | | Encode |
| Intra | Symmetrical | Asymmetrical | Split | Split | Coding |
| Inter | Partition | Partition | Information 0 | Information 1 | Units |
| Skip | Type | Type | of | of | having |
| (Only | | | Transformation | Transformation | Lower |
| 2N × 2N) | | | Unit | Unit | Depth of |
| | 2N × 2N | 2N × nU | 2N × 2N | N × N | d + 1 |
| | 2N × N | 2N × nD | | (Symmetrical | |
| | N × 2N | nL × 2N | | Type) | |
| | N × N | nR × 2N | | N/2 × N/2 | |
| | | | | (Asymmetrical | |
| | | | | Type) | |

The output unit 130 of the video encoding apparatus 100 according to an exemplary embodiment may output the encoding information about the coding units having a tree structure, and the image data and encoding information extractor 220 of the video decoding apparatus 200 according to an exemplary embodiment may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. If a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure, according to an exemplary embodiment, may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. A corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

FIG. 20 is a diagram for describing a relationship between a coding unit, a prediction unit, and a transformation unit, according to encoding mode information of Table 5.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Split information (TU size flag) of a transformation unit is a type of a transformation index. The size of the transformation unit corresponding to the transformation index may be changed according to a prediction unit type or partition type of the coding unit.

For example, when the partition type is set to be symmetrical, i.e. the partition type 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 20, the TU size flag is a flag having a value or 0 or 1, but the TU size flag according to an exemplary embodiment is not limited to 1 bit, and a transformation unit may be hierarchically split having a tree structure while the TU size flag increases from 0. Split information (TU size flag) of a transformation unit may be an example of a transformation index.

In this case, the size of a transformation unit that has been actually used may be expressed by using a TU size flag of a transformation unit, according to an exemplary embodiment, together with a maximum size and minimum size of the transformation unit. The video encoding apparatus 100 according to an exemplary embodiment is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 according to an exemplary embodiment may decode video by using the maximum transformation unit size information, the minimum transformation unit size information, and the maximum TU size flag.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an exemplary embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and TUSize′ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the present disclosure is not limited thereto.

According to the video encoding method based on coding units having a tree structure as described with reference to FIGS. 8 through 20, image data of a spatial region is encoded for each coding unit of a tree structure. According to the video decoding method based on coding units having a tree structure, decoding is performed for each maximum coding unit to reconstruct image data of a spatial region. Thus, a picture and a video that is a picture sequence may be reconstructed. The reconstructed video may be reproduced by a reproducing apparatus, stored in a storage medium, or transmitted through a network.

The exemplary embodiments according to the present disclosure may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

For convenience of description, the video stream encoding method and/or the video encoding method described above with reference to FIGS. 1A through 20 will be collectively referred to as a ‘video encoding method of the present disclosure’. In addition, the video stream decoding method and/or the video decoding method described above with reference to FIGS. 1A through 20 will be referred to as a ‘video decoding method of the present disclosure’.

A video encoding apparatus including the video stream encoding apparatus 10, the video encoding apparatus 100, or the image encoder 400, which has been described with reference to FIGS. 1A through 20, will be referred to as a ‘video encoding apparatus of the present disclosure’. In addition, a video decoding apparatus including the video stream decoding apparatus 20, the video decoding apparatus 200, or the image decoder 500, which has been descried with reference to FIGS. 1A through 20, will be referred to as a ‘video decoding apparatus of the present disclosure’.

A computer-readable recording medium storing a program, e.g., a disc 26000, according to an exemplary embodiment of the present disclosure will now be described in detail.

FIG. 21 is a diagram of a physical structure of the disc 26000 in which a program is stored, according to various exemplary embodiments. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000 according to the exemplary embodiment, a program that executes the quantization parameter determining method, the video encoding method, and the video decoding method described above may be assigned and stored.

A computer system embodied using a storage medium that stores a program for executing the video encoding method and the video decoding method as described above will now be described with reference to FIG. 22.

FIG. 22 is a diagram of a disc drive 26800 for recording and reading a program by using the disc 26000. A computer system 27000 may store a program that executes at least one of the video encoding method and the video decoding method of the present disclosure, in the disc 26000 via the disc drive 26800. To run the program stored in the disc 26000 in the computer system 27000, the program may be read from the disc 26000 and be transmitted to the computer system 26700 by using the disc drive 27000.

The program that executes at least one of the video encoding method and the video decoding method of the present disclosure may be stored not only in the disc 26000 illustrated in FIG. 21 or 22 but also in a memory card, a ROM cassette, or a solid state drive (SSD).

A system to which the video encoding method and a video decoding method described above are applied will be described below.

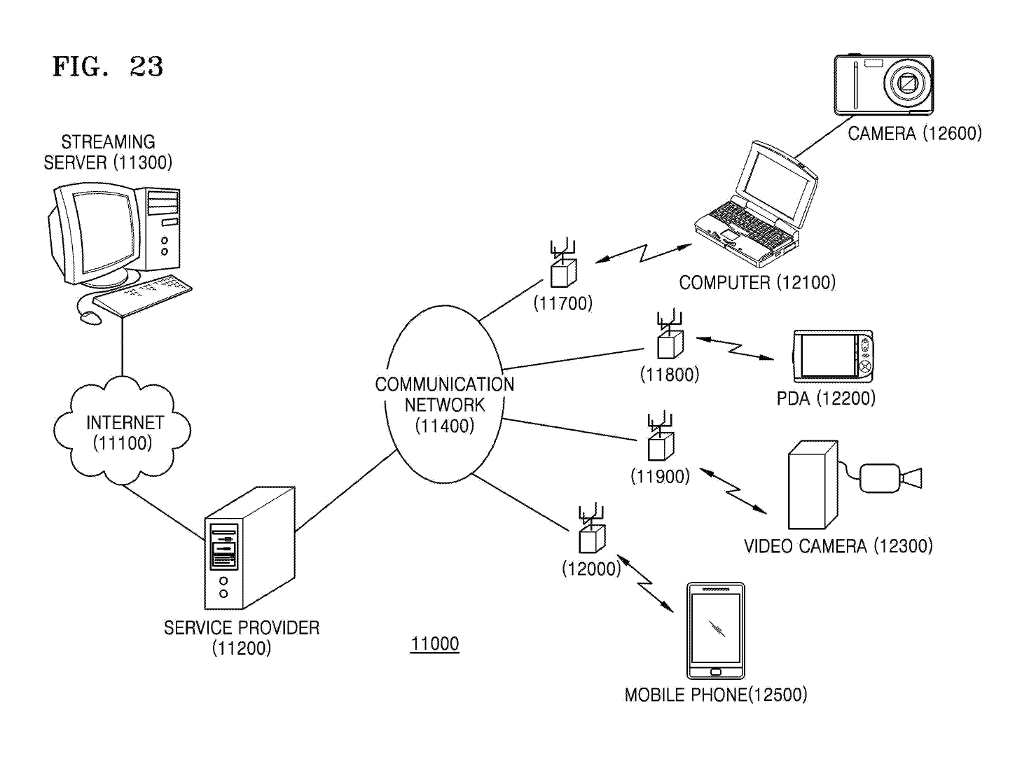

FIG. 23 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

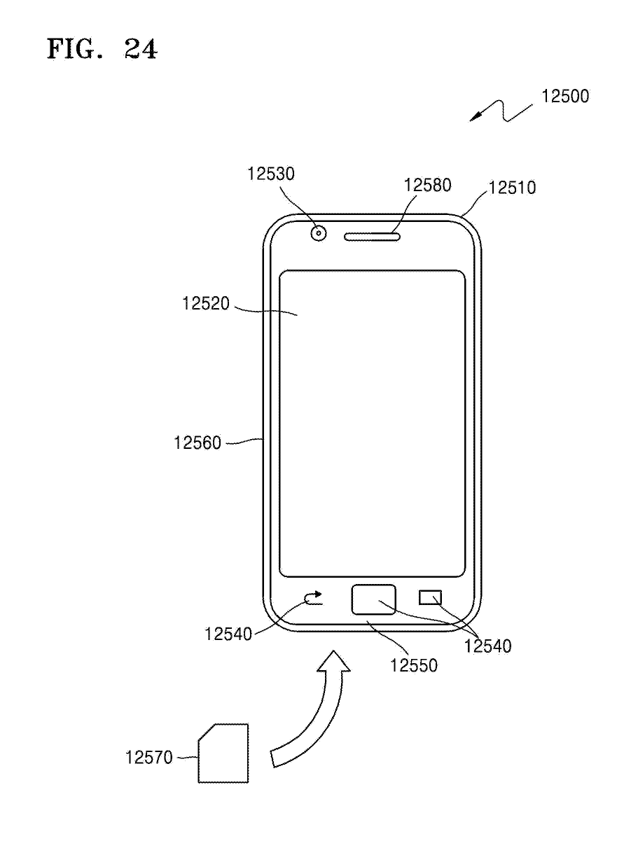

However, the content supply system 11000 is not limited to as illustrated in FIG. 24, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded using the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 according to an exemplary embodiment may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. The content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of the video encoding apparatus and the video decoding apparatus of the present disclosure.

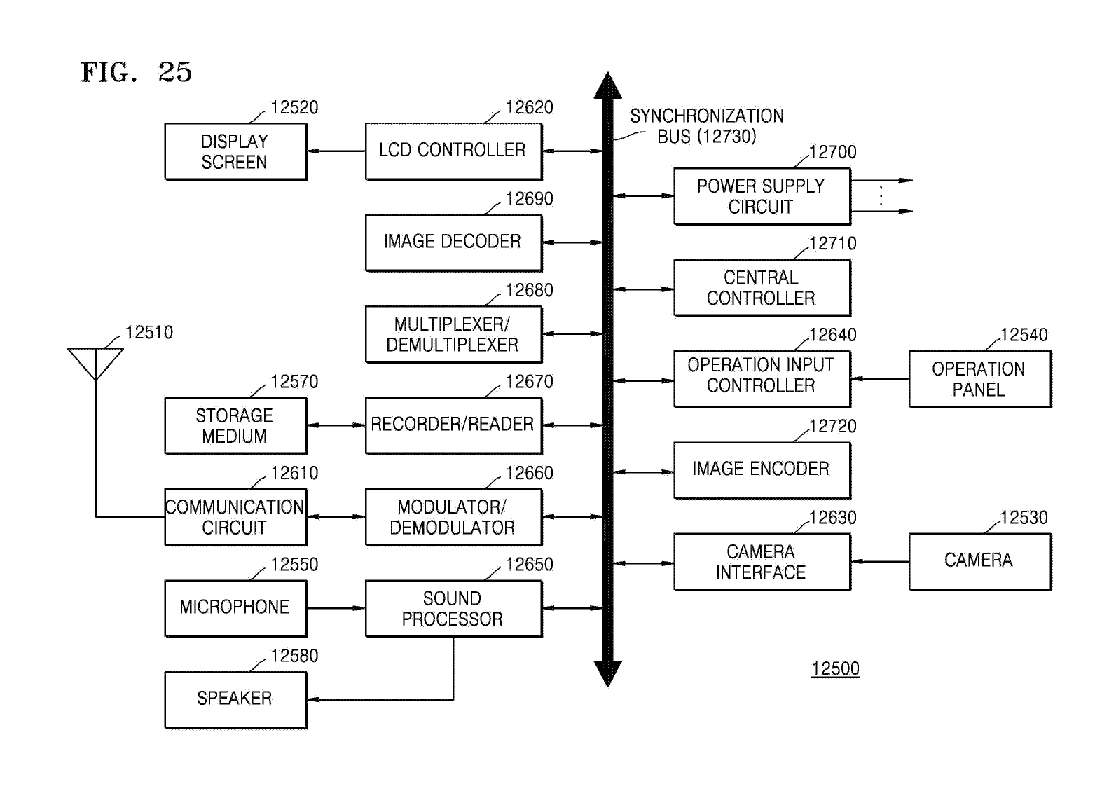

The mobile phone 12500 included in the content supply system 11000 according to an exemplary embodiment will now be described in greater detail with referring to FIGS. 24 and 25.

FIG. 24 illustrates an external structure of the mobile phone 12500 to which the video encoding method and the video decoding method of the present disclosure are applied, according to various exemplary embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound output unit, and a microphone 12550 for inputting voice and sound or another type sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500, according to an exemplary embodiment of the present disclosure. To systemically control parts of the mobile phone 12500 including the display screen 12520 and the operation panel 12540, a power supply circuit 12700, an operation input controller 12640, an image encoding unit 12720, a camera interface 12630, an LCD controller 12620, an image decoding unit 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off’ state to a power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoding unit 12720 may generate a digital image signal, and text data of a message may be generated via the operation panel 12540 and the operation input controller 12640. When a digital signal is transmitted to the modulation/demodulation unit 12660 under control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulation/demodulation unit 12660 and the communication circuit 12610, and may be transmitted via the antenna 12510.

When a text message, e.g., email, is transmitted in a data communication mode, text data of the text message is input via the operation panel 12540 and is transmitted to the central controller 12610 via the operation input controller 12640. Under control of the central controller 12610, the text data is transformed into a transmission signal via the modulation/demodulation unit 12660 and the communication circuit 12610 and is transmitted to the wireless base station 12000 via the antenna 12510.

To transmit image data in the data communication mode, image data captured by the camera 12530 is provided to the image encoding unit 12720 via the camera interface 12630. The captured image data may be directly displayed on the display screen 12520 via the camera interface 12630 and the LCD controller 12620.

A structure of the image encoding unit 12720 may correspond to that of the video encoding apparatus 100 described above. The image encoding unit 12720 may transform the image data received from the camera 12530 into compressed and encoded image data according to the video encoding method of the present disclosure described above, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoding unit 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulation/demodulation unit 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulation/demodulation unit 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoding unit 12690 may correspond to that of the video decoding apparatus of the present disclosure described above. The image decoding unit 12690 may decode the encoded video data to obtain reconstructed video data and provide the reconstructed video data to the display screen 12520 via the LCD controller 12620, by using the video decoding method of the present disclosure described above.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both the video encoding apparatus and the video decoding apparatus of the present disclosure, may be a transceiving terminal including only the video encoding apparatus of the present disclosure, or may be a transceiving terminal including only the video decoding apparatus of the present disclosure.

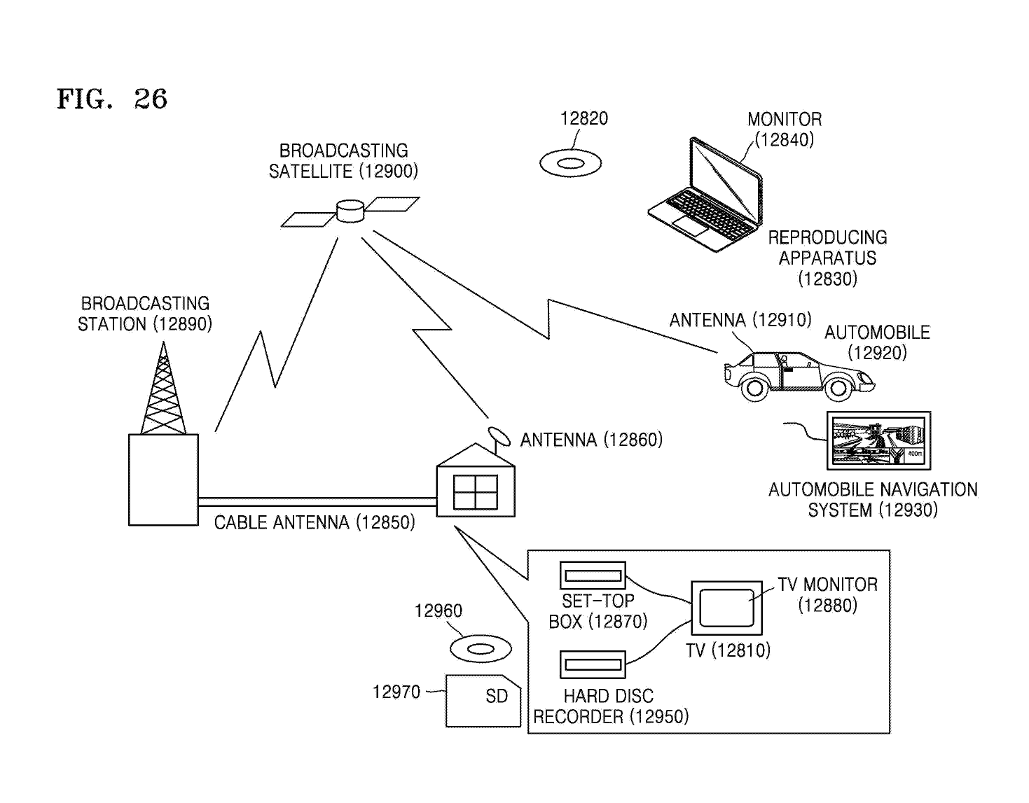

A communication system according to the present disclosure is not limited to the communication system described above with reference to FIG. 24. For example, FIG. 26 illustrates a digital broadcasting system employing a communication system, according to various exemplary embodiments. The digital broadcasting system of FIG. 26 according to an exemplary embodiment may receive a digital broadcast transmitted via a satellite or a terrestrial network by using the video encoding apparatus and the video decoding apparatus of the present disclosure.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When the video decoding apparatus of the present disclosure is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, the video decoding apparatus of the present disclosure may be installed. Data output from the set-top box 12870 may also be reproduced on a TV monitor 12880.

As another example, the video decoding apparatus of the present disclosure may be installed in the TV receiver 12810 instead of the set-top box 12870.

An automobile 12920 that has an appropriate antenna 12910 may receive a signal transmitted from the satellite 12900 or the wireless base station 11700 of FIG. 23. A decoded video may be reproduced on a display screen of an automobile navigation system 12930 installed in the automobile 12920.

A video signal may be encoded by the video encoding apparatus of the present disclosure and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes the video decoding apparatus of the present disclosure according to an exemplary embodiment, a video signal recorded on the DVD disc 12960, the SD card 12970, or another storage medium may be reproduced on the TV monitor 12880.

The automobile navigation system 12930 may not include the camera 12530, the camera interface 12630, and the image encoding unit 12720 of FIG. 26. For example, the computer 12100 and the TV receiver 12810 may not be included in the camera 12530, the camera interface 12630, and the image encoding unit 12720 of FIG. 26.

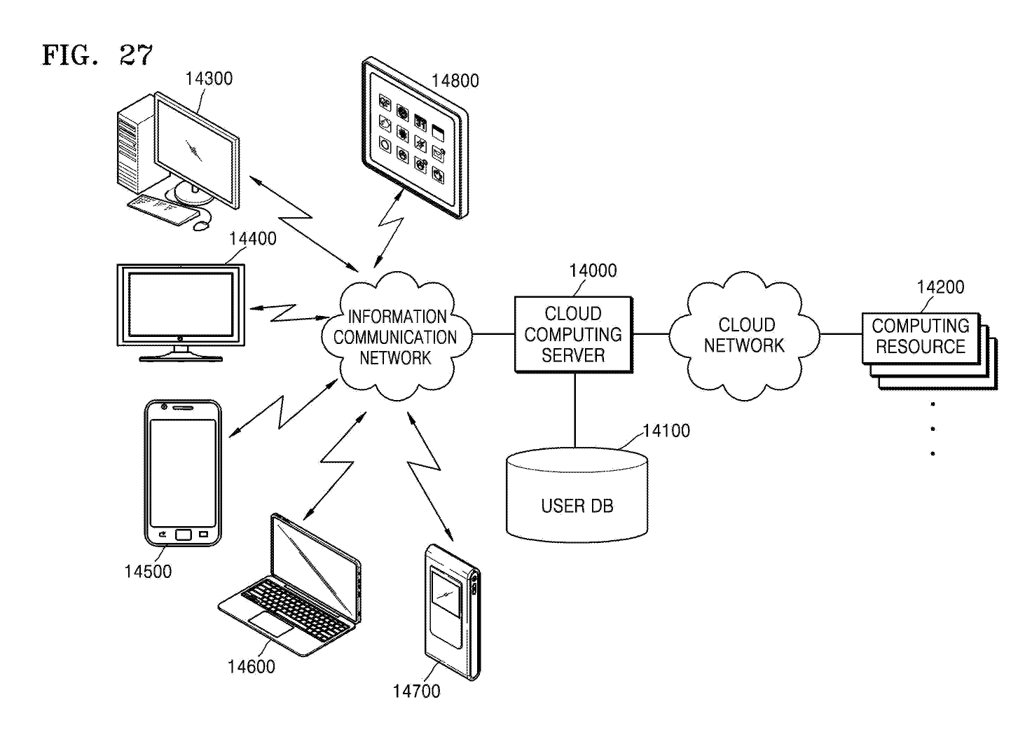

FIG. 27 is a diagram illustrating a network structure of a cloud computing system using a video encoding apparatus and a video decoding apparatus, according to various exemplary embodiments.

The cloud computing system of the present disclosure may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include the video decoding apparatus of the present disclosure described above with reference to FIGS. 1A to 20. As another example, the user terminal may include the video encoding apparatus of the present disclosure described above with reference to FIGS. 1A to 20. Alternatively, the user terminal may include both the video decoding apparatus and the video encoding apparatus of the present disclosure described above with reference to FIGS. 1A to 20.

Various applications of a video encoding method, a video decoding method, a video encoding apparatus, and a video decoding apparatus according to exemplary embodiments described above with reference to FIGS. 1A to 20 have been described above with reference to FIGS. 21 to 27. However, methods of storing the video encoding method and the video decoding method in a storage medium or methods of implementing the video encoding apparatus and the video decoding apparatus in a device, according to various exemplary embodiments, are not limited to the exemplary embodiments described above with reference to FIGS. 21 to 27.

It will be understood by those of ordinary skill in the art that various changes in form and details may be made in various exemplary embodiments without departing from the spirit and scope of the exemplary embodiments described herein. The exemplary embodiments should be considered in a descriptive sense only and not for purposes of limitation. Therefore, the scope of the present disclosure is defined not by the detailed description of the present disclosure but by the appended claims, and all differences within the scope will be construed as being included in the present disclosure.

1. An image decoding method comprising:
obtaining a first identifier of at least one decoding target layer image from among a plurality of layer images from a bitstream comprising a plurality of pieces of layer encoding image data;
obtaining a second identifier comprising information expressing a layer identifier outside of an expression range of the first identifier from the bitstream;
determining a layer identifier based on the first and second identifiers; and
reconstructing an image by decoding the decoding target layer image by using the determined layer identifier.

2. The image decoding method of claim 1, wherein the determining the layer identifier comprises determining the layer identifier by using the first and second identifiers when the first identifier indicates a maximum value of the first identifier.

3. The image decoding method of claim 1, further comprising obtaining, from the bitstream, expansion indication information indicating whether the second identifier comprises information for the layer identifier,
wherein the determining the layer identifier comprises determining whether to use the second identifier for determining the layer identifier according to the expansion indication information.

4. The image decoding method of claim 1, wherein the second identifier is obtained from at least one from among a slice header, a parameter set header, and a network abstract layer (NAL) unit header.

5. The image decoding method of claim 1, wherein the reconstructing the image comprises:
obtaining output layer information in an output layer set from the bitstream by using an expanded maximum layer identifier; and
decoding the target layer image by using the output layer information.

6. The image decoding method of claim 5, wherein the obtaining the output layer information comprises:
obtaining an identifier of a maximum layer in a video parameter set from the bitstream;
obtaining a number of bits assigned to the second identifier; and
determining an identifier of an expanded maximum layer based on the number of bits assigned to the second identifier and the maximum layer identifier.

7. The image decoding method of claim 1, wherein the reconstructing the image comprises:
obtaining inter-layer direct reference information according to a maximum number of expanded layers; and
decoding the target layer image by using the inter-layer direct reference information.

8. The image decoding method of claim 7, wherein the obtaining the inter-layer direct reference information comprises:
obtaining an identifier indicating a maximum layer number in a video parameter set from the bitstream;
obtaining a number of bits assigned to the second identifier; and
determining the maximum number of the expanded layers based on the identifier indicating the maximum layer number and a number of bits assigned to the expanded identifier.

9. An image encoding method comprising:
generating encoding data of at least one encoding target layer image from among a plurality of layer images by using an input image; and
generating a bitstream by using a first identifier expressing a layer identifier of the encoding target layer image and a second identifier for expressing a layer identifier outside of an expression range of the first identifier.

10. The image encoding method of claim 9, wherein the generating of the bitstream by using the first identifier expressing the layer identifier of the encoding target layer image and the second identifier for expressing the layer identifier outside the expression range of the first identifier comprises setting the first identifier to have a maximum value when the layer identifier exceeds a range expressing the first identifier.

11. The image encoding method of claim 9, wherein the bitstream further comprises expansion indication information indicating that the second identifier comprises information for expressing the layer identifier.

12. The image encoding method of claim 9, wherein the encoding target layer image is an enhancement layer image, and when a value of a temporal identifier of the encoding target layer image is same as a value of a temporal identifier of a base layer image, the temporal identifier of the encoding target layer image is used as the second identifier.

13. An image decoding apparatus comprising:
a bitstream parser configured to obtain a first identifier of at least one decoding target layer image from among a plurality of layer images from a bitstream comprising a plurality of pieces of layer encoding image data, and obtain a second identifier comprising information expressing a layer identifier outside of an expression range of the first identifier from the bitstream; and
a decoder configured to reconstruct an image by decoding the decoding target layer image by using a layer identifier determined based on the first and second identifiers.

14. An image encoding apparatus comprising:
an encoder configured to generate encoding data of at least one encoding target layer image from among a plurality of layer images by using an input image; and
a bitstream generator configured to generate a bitstream by using a first identifier expressing a layer identifier of the encoding target layer image and a second identifier for expressing a layer identifier outside of an expression range of the first identifier.

15. A non-transitory computer-readable recording medium having recorded thereon a program, which when executed by a computer, performed the method of claim 1.
